(19) United States
(12) Patent Application Publication
(10) Pub. No.: US 2023/0373146 A1
(43) Pub. Date: Nov. 23, 2023

(54) INJECTION MOLDING MACHINE

(71) Applicant: SUMITOMO HEAVY INDUSTRIES, LTD., Tokyo (JP)

(72) Inventors: Daigo HOTTA, Chiba-shi (JP); Yuki MATSUI, Chiba-shi (JP); Yutaka TSUTSUMI, Chiba-shi (JP); Hajime ONO, Chiba-shi (JP)

(21) Appl. No.: 18/365,882

(22) Filed: Aug. 4, 2023

Related U.S. Application Data
(63) Continuation of application No. PCT/JP2022/016278, filed on Mar. 30, 2022.

(30) Foreign Application Priority Data
Mar. 31, 2021 (JP) 2021-062410

(51) Int. Cl. B29C 45/78; B29C 45/20

(52) U.S. Cl. CPC B29C 45/78; B29C 45/20; B29C 2945/7604; B29C 2945/76287; B29C 2945/76257; B29C 2945/76531; B29C 2945/76688; B29C 2945/76939

(57) ABSTRACT

An injection molding machine includes a nozzle that is provided in an injection device filling a mold device with a molding material, a nozzle temperature measurement unit that measures a temperature of the nozzle, an in-mold temperature measurement unit that measures a temperature of the molding material in the mold device, and a control device that controls the temperature of the nozzle on the basis of a measured nozzle temperature measured by the nozzle temperature measurement unit and a measured in-mold temperature measured by the in-mold temperature measurement unit.

### CROSS-REFERENCE TO RELATED APPLICATIONS

This is a bypass continuation of International PCT Application No. PCT/JP2022/016278, filed on Mar. 30, 2022, which claims priority to Japanese Patent Application No. 2021-062410, filed on Mar. 31, 2021, which are incorporated by reference herein in their entirety.

### BACKGROUND

### Technical Field

Certain embodiments of the present invention relate to an injection molding machine.

### Description of Related Art

In the related art, it is necessary to appropriately control a temperature of a molding material to mold a molding product in an injection molding machine. Accordingly, the temperature of a nozzle for injecting a molding material is measured and a heating unit provided on the nozzle is controlled so that the temperature of the molding material to be injected reaches an appropriate temperature.

For example, the related art proposes an injection molding machine that is provided with a nozzle heater heating a nozzle and a cylinder heater heating a cylinder. The technology disclosed in the related art proposes a technique that causes the nozzle heater and the cylinder heater to be in close contact with a mold device before the start of actual molding to stabilize the temperatures of the mold device and the like in advance. Accordingly, a technique for shortening a time required until the start of molding is proposed.

### SUMMARY

An aspect of the present invention provides a technique that suppresses a variation in the temperature of a molding material in a mold device to improve the stability of the molding of molding products.

An injection molding machine according to an aspect of the present invention includes a nozzle, a nozzle temperature measurement unit, an in-mold temperature measurement unit, and a control device. The nozzle is provided in an injection device filling cavity spaces formed in a mold device with a molding material. The nozzle temperature measurement unit measures a temperature of the nozzle. The in-mold temperature measurement unit measures a temperature of the molding material in the mold device. The control device controls the temperature of the nozzle on the basis of a measured nozzle temperature that is measured by the nozzle temperature measurement unit and a measured in-mold temperature that indicates the temperature measured by the in-mold temperature measurement unit.

### BRIEF DESCRIPTION OF THE DRAWINGS

FIG. 1 is a diagram showing a state of an injection molding machine according to an embodiment at the time of completion of mold opening.

FIG. 2 is a diagram showing a state of the injection molding machine according to the embodiment at the time of mold clamping.

FIG. 3 is a diagram illustrating a disposition around a temperature sensor of one embodiment that is used to measure a temperature of a molding material in cavity spaces provided in a mold device.

FIG. 4 is a diagram illustrating a disposition around a temperature sensor of a modification example of the embodiment that is used to measure a temperature of a molding material on a flow channel provided in the mold device.

FIG. 5 is a diagram showing a configuration example of a control device of the embodiment.

FIG. 6 is a diagram illustrating a change in a temperature that is measured by a surface temperature measurement sensor of the embodiment in a case where the mold device is filled with a molding material.

FIG. 7 is a diagram illustrating a change in a temperature that is measured by the surface temperature measurement sensor of the embodiment for each shot of a molding material with which the mold device is filled.

FIG. 8 is a diagram illustrating a temperature setting screen that is displayed by a display control device of the embodiment and that is used to control a temperature of a nozzle.

FIG. 9 is a diagram showing a configuration example of a control device of another embodiment.

FIG. 10 is a diagram illustrating a temperature setting screen that is displayed by a display control device of another embodiment and that is used to control temperatures of a nozzle and a cylinder.

### DETAILED DESCRIPTION

In the related art, a technique for shortening a time by heating the mold device and the like with the nozzle heater and the cylinder heater is disclosed, and the adjustment of the temperature of the molding material to be injected from the nozzle is not considered.

That is, even in a case where a temperature set in the nozzle heater is a predetermined temperature, the temperature of the molding material injected into the mold device may be different from an expected temperature, or a variation in temperature may occur due to disturbance, such as an individual difference of the injection molding machine or the temperature of outside air. For example, a difference in a method of providing a thermocouple, which is provided on the nozzle and is used to detect a temperature, is conceivable as the individual difference of the injection molding machine.

Embodiments of the present invention will be described below with reference to the drawings. The same or corresponding components will be denoted in the respective drawings by the same or corresponding reference numerals, and the description thereof will be omitted.

### Injection Molding Machine

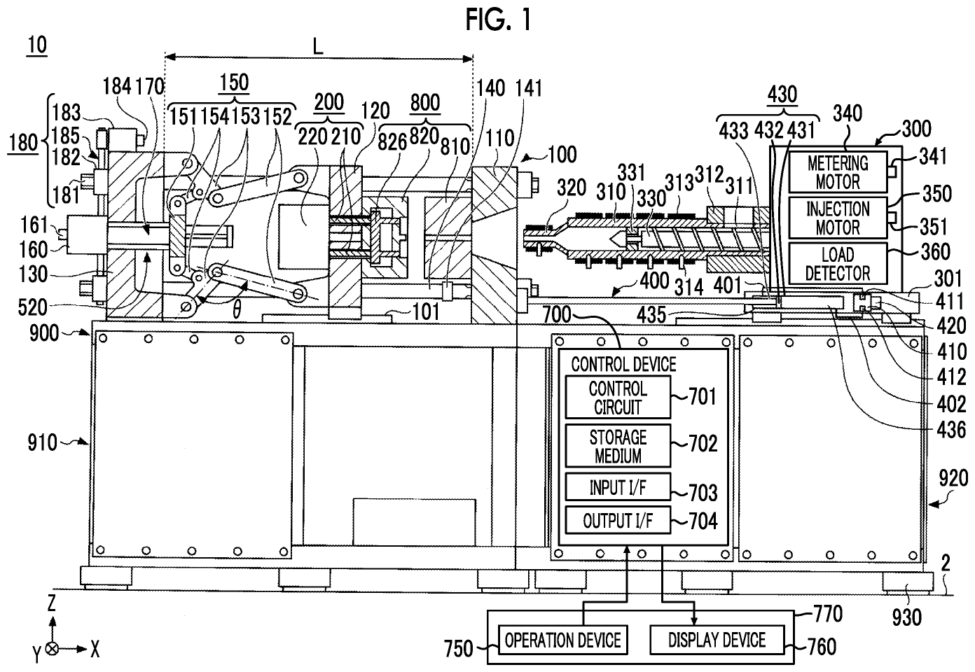

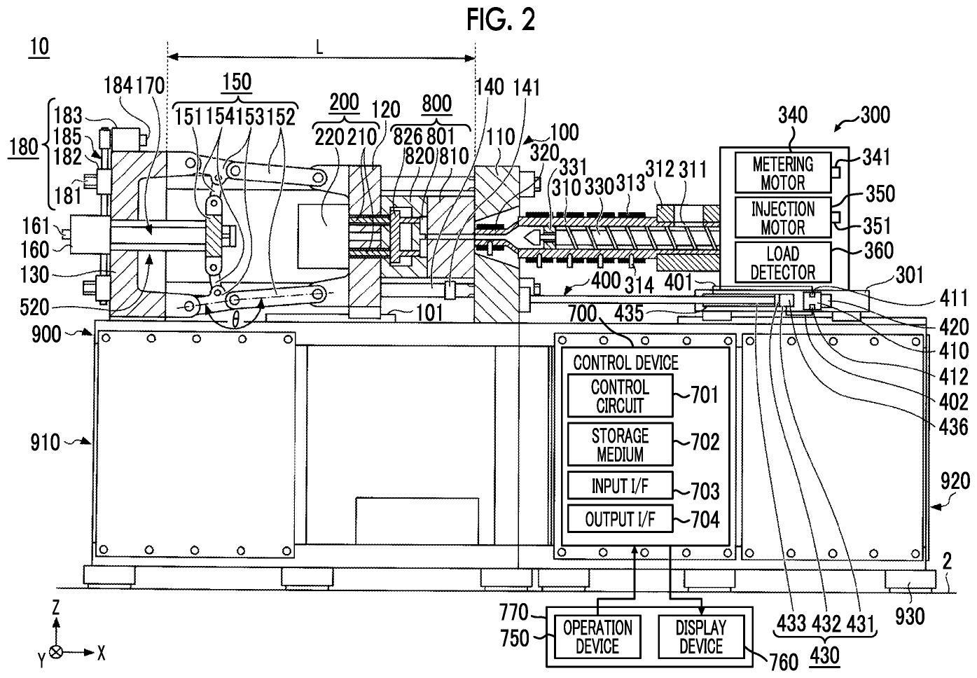

FIG. 1 is a diagram showing a state of an injection molding machine according to an embodiment at the time of completion of mold opening. FIG. 2 is a diagram showing a state of the injection molding machine according to the embodiment at the time of mold clamping. In this specification, an X-axis direction, a Y-axis direction, and a Z-axis direction are directions perpendicular to each other. The X-axis direction and the Y-axis direction indicate horizontal directions, and the Z-axis direction indicates a vertical direction. In a case where a mold clamping device 100 is a horizontal type, the X-axis direction is a mold opening/closing direction and the Y-axis direction is a width direction of the injection molding machine 10. A negative side in the Y-axis direction is referred to as an operation side, and a positive side in the Y-axis direction is referred to as a counter-operation side.

As shown in FIGS. 1 and 2, the injection molding machine 10 includes a mold clamping device 100 that opens and closes a mold device 800, an ejector device 200 that ejects molding products molded by the mold device 800, an injection device 300 that injects a molding material into the mold device 800, a moving device 400 that causes the injection device 300 to advance and retreat with respect to the mold device 800, a control device 700 that controls the respective components of the injection molding machine 10, and a frame 900 that supports the respective components of the injection molding machine 10. The frame 900 includes a mold clamping device frame 910 that supports the mold clamping device 100, and an injection device frame 920 that supports the injection device 300. The mold clamping device frame 910 and the injection device frame 920 are installed on a floor 2 via leveling adjusters 930, respectively. The control device 700 is disposed in an internal space of the injection device frame 920. The respective components of the injection molding machine 10 will be described below.

### Mold Clamping Device

In the description of the mold clamping device 100, a moving direction of a movable platen 120 in a case where a mold is to be closed (for example, an X-axis positive direction) will correspond to a front, and a moving direction of the movable platen 120 in a case where the mold is to be opened (for example, an X-axis negative direction) will correspond to a rear.

The mold clamping device 100 performs mold closing, pressurization, mold clamping, depressurization, and mold opening of the mold device 800. The mold device 800 includes a stationary mold 810 and a movable mold 820.

The mold clamping device 100 is, for example, a horizontal type, and the mold opening/closing direction of the mold clamping device 100 is a horizontal direction. The mold clamping device 100 includes a stationary platen 110 to which the stationary mold 810 is attached, a movable platen 120 to which the movable mold 820 is attached, and a moving mechanism 102 that moves the movable platen 120 with respect to the stationary platen 110 in the mold opening/closing direction.

The stationary platen 110 is fixed to the mold clamping device frame 910. The stationary mold 810 is attached to the surface of the stationary platen 110 facing the movable platen 120.

The movable platen 120 is disposed to be movable with respect to the mold clamping device frame 910 in the mold opening/closing direction. Guides 101 that guide the movable platen 120 are laid on the mold clamping device frame 910. The movable mold 820 is attached to the surface of the movable platen 120 facing the stationary platen 110.

The moving mechanism 102 causes the movable platen 120 to advance and retreat with respect to the stationary platen 110 to perform mold closing, pressurization, mold clamping, depressurization, and mold opening of the mold device 800. The moving mechanism 102 includes a toggle support 130 that is disposed with an interval between the stationary platen 110 and itself, a tie bar 140 that connects the stationary platen 110 to the toggle support 130, a toggle mechanism 150 that moves the movable platen 120 with respect to the toggle support 130 in the mold opening/closing direction, a mold clamping motor 160 that operates the toggle mechanism 150, a motion conversion mechanism 170 that converts a rotary motion of the mold clamping motor 160 into a linear motion, and a mold space adjustment mechanism 180 that adjusts an interval between the stationary platen 110 and the toggle support 130.

The toggle support 130 is disposed with an interval between the stationary platen 110 and itself, and is placed on the mold clamping device frame 910 to be movable in the mold opening/closing direction. The toggle support 130 may be disposed to be movable along guides laid on the mold clamping device frame 910. The guides for the toggle support 130 may be common to the guides 101 for the movable platen 120.

In the present embodiment, the stationary platen 110 is fixed to the mold clamping device frame 910, and the toggle support 130 is disposed to be movable with respect to the mold clamping device frame 910 in the mold opening/closing direction. However, the toggle support 130 may be fixed to the mold clamping device frame 910, and the stationary platen 110 may be disposed to be movable with respect to the mold clamping device frame 910 in the mold opening/closing direction.

The tie bar 140 connects the stationary platen 110 to the toggle support 130 with an interval L between the stationary platen 110 and the toggle support 130 in the mold opening/closing direction. A plurality of (for example, four) tie bars 140 may be used. The plurality of tie bars 140 are disposed parallel to the mold opening/closing direction and extend depending on a mold clamping force. At least one tie bar 140 may be provided with a tie bar strain detector 141 that detects the strain of the tie bar 140. The tie bar strain detector 141 sends a signal indicating the detection result thereof to the control device 700. The detection result of the tie bar strain detector 141 may be used for the measurement of a mold clamping force, and the like.

The tie bar strain detector 141 is used in the present embodiment as a mold clamping force detector for detecting a mold clamping force, but the present invention is not limited thereto. The mold clamping force detector is not limited to a strain gauge type and may be a piezoelectric type, a capacitive type, a hydraulic type, an electromagnetic type, or the like. A position where the mold clamping force detector is attached is also not limited to the tie bar 140.

The toggle mechanism 150 is disposed between the movable platen 120 and the toggle support 130, and moves the movable platen 120 with respect to the toggle support 130 in the mold opening/closing direction. The toggle mechanism 150 includes a crosshead 151 that moves in the mold opening/closing direction and a pair of link groups that is bent and stretched depending on the movement of the crosshead 151. Each of the pair of link groups includes a first link 152 and a second link 153 that are bendably and stretchably connected to each other by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. In a case where the crosshead 151 is caused to advance and retreat with respect to the toggle support 130, the first and second links 152 and 153 are bent and stretched, and the movable platen 120 advances and retreats with respect to the toggle support 130.

The configuration of the toggle mechanism 150 is not limited to the configuration shown in FIGS. 1 and 2. For example, the number of nodes of each link group is five in FIGS. 1 and 2 but may be four. One end portion of the third link 154 may be connected to the node between the first and second links 152 and 153.

The mold clamping motor 160 is attached to the toggle support 130 and operates the toggle mechanism 150. The mold clamping motor 160 causes the crosshead 151 to advance and retreat with respect to the toggle support 130, so that the first and second links 152 and 153 are bent and stretched to cause the movable platen 120 to advance and retreat with respect to the toggle support 130. The mold clamping motor 160 is directly connected to the motion conversion mechanism 170, but may be connected to the motion conversion mechanism 170 via a belt, pulleys, and the like.

The motion conversion mechanism 170 converts a rotary motion of the mold clamping motor 160 into a linear motion of the crosshead 151. The motion conversion mechanism 170 includes a screw shaft and a screw nut that is screwed to the screw shaft. Balls or rollers may be interposed between the screw shaft and the screw nut.

The mold clamping device 100 performs a mold closing process, a pressurization process, a mold clamping process, a depressurization process, a mold opening process, and the like under the control of the control device 700.

In the mold closing process, the mold clamping motor 160 is driven to cause the crosshead 151 to advance up to a mold closing completion position at a set movement speed, so that the movable platen 120 is caused to advance and causes the movable mold 820 to touch the stationary mold 810. The position and the movement speed of the crosshead 151 are measured using, for example, a mold clamping motor encoder 161 or the like. The mold clamping motor encoder 161 measures the rotation of the mold clamping motor 160, and sends a signal indicating the detection result thereof to the control device 700.

A crosshead position detector for measuring the position of the crosshead 151 and a crosshead movement speed detector for measuring the movement speed of the crosshead 151 are not limited to the mold clamping motor encoder 161, and general detectors can be used. Further, a movable platen position detector for measuring the position of the movable platen 120 and a movable platen movement speed detector for measuring the movement speed of the movable platen 120 are not limited to the mold clamping motor encoder 161, and general detectors can be used.

In the pressurization process, the mold clamping motor 160 is further driven to further cause the crosshead 151 to advance from the mold closing completion position up to a mold clamping position and to generate a mold clamping force.

In the mold clamping process, the mold clamping motor 160 is driven to maintain the position of the crosshead 151 at the mold clamping position. In the mold clamping process, the mold clamping force generated in the pressurization process is maintained. In the mold clamping process, cavity spaces 801 (see FIG. 2) are formed between the movable mold 820 and the stationary mold 810, and the injection device 300 fills the cavity spaces 801 with liquid molding material. Molding products are obtained in a case where the molding material filling the cavity spaces is solidified.

An example in which a plurality of cavity spaces 801 shown in FIGS. 1 and 2 are provided is described, but one cavity space may be provided. In the former case, a plurality of molding products are obtained at the same time. Insert materials may be disposed in a part of the cavity spaces 801, and the other part of the cavity spaces 801 may be filled with a molding material. Molding products in which the insert materials and the molding material are integrated with each other are obtained.

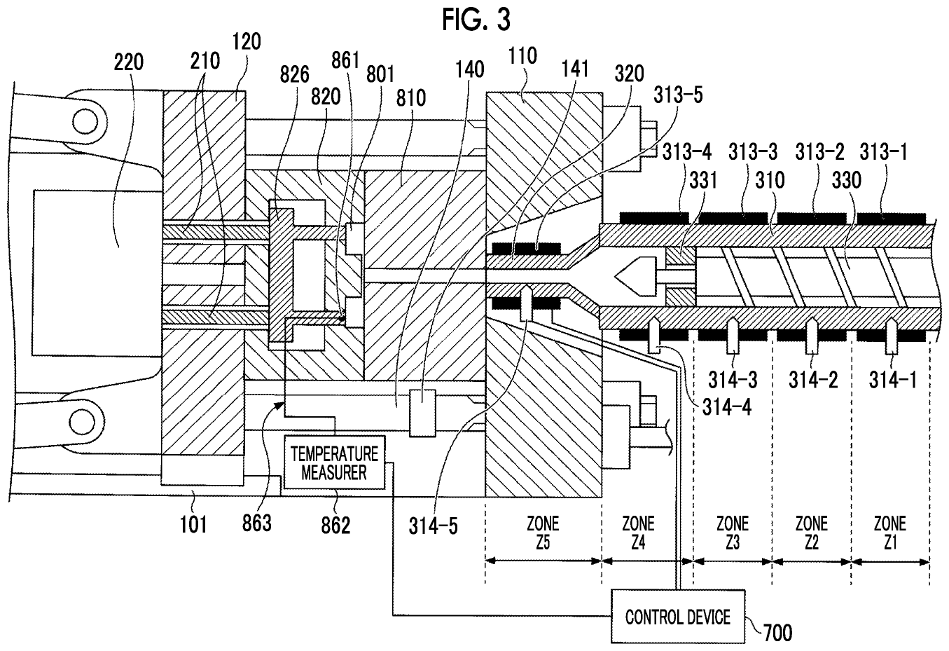

A surface temperature measurement sensor 861, a temperature measurer 862, and a conversion cable 863 (see FIG. 3), which are used to measure a temperature of the molding material in the cavity spaces 801, are provided in the present embodiment.

In the depressurization process, the mold clamping motor 160 is driven to cause the crosshead 151 to retreat from the mold clamping position up to a mold opening start position, so that the movable platen 120 is caused to retreat to reduce the mold clamping force. The mold opening start position and the mold closing completion position may be the same position.

In the mold opening process, the mold clamping motor 160 is driven to cause the crosshead 151 to retreat from the mold opening start position up to a mold opening completion position at a set movement speed, so that the movable platen 120 is caused to retreat and causes the movable mold 820 to be separated from the stationary mold 810. After that, the ejector device 200 ejects the molding products from the movable mold 820.

Set conditions in the mold closing process, the pressurization process, and the mold clamping process are collectively set as a series of set conditions. For example, movement speeds and positions (including a mold closing start position, a movement speed switching position, a mold closing completion position, and a mold clamping position) of the crosshead 151 and mold clamping forces in the mold closing process and the pressurization process are collectively set as a series of set conditions. The mold closing start position, the movement speed switching position, the mold closing completion position, and the mold clamping position are arranged in this order from a rear side toward the front, and indicate starting points and end points of sections in which the movement speeds are set. The movement speed is set for each section. One movement speed switching position may be set, or a plurality of movement speed switching positions may be set. The movement speed switching position may not be set. Only one of the mold clamping position and the mold clamping force may be set.

Set conditions in the depressurization process and the mold opening process are also collectively set in the same manner. For example, movement speeds and positions (including the mold opening start position, the movement speed switching position, and the mold opening completion position) of the crosshead 151 in the depressurization process and the mold opening process are collectively set as a series of set conditions. The mold opening start position, the movement speed switching position, and the mold opening completion position are arranged in this order from a front side toward the rear, and indicate starting points and end points of sections in which the movement speeds are set. The movement speed is set for each section. One movement speed switching position may be set, or a plurality of movement speed switching positions may be set. The movement speed switching position may not be set. The mold opening start position and the mold closing completion position may be the same position. Further, the mold opening completion position and the mold closing start position may be the same position.

The movement speeds, the positions, and the like of the movable platen 120 may be set instead of the movement speeds, the positions, and the like of the crosshead 151. Further, a mold clamping force may be set instead of the position (for example, the mold clamping position) of the crosshead or the position of the movable platen.

The toggle mechanism 150 amplifies the driving force of the mold clamping motor 160 and transmits the amplified driving force to the movable platen 120. The amplification factor of the toggle mechanism 150 is also referred to as a toggle factor. The toggle factor is changed depending on an angle θ between the first and second links 152 and 153 (hereinafter, also referred to as a “link angle θ”). The link angle θ is obtained from the position of the crosshead 151. In a case where the link angle θ is 180°, the toggle factor is at its maximum.

In a case where the space of the mold device 800 is changed due to the replacement of the mold device 800, a temperature change of the mold device 800, or the like, a mold space is adjusted such that a predetermined mold clamping force is obtained during mold clamping. In the adjustment of a mold space, the interval L between the stationary platen 110 and the toggle support 130 is adjusted such that the link angle θ of the toggle mechanism 150 is a predetermined angle at a point of mold touch time when, for example, the movable mold 820 touches the stationary mold 810.

The mold clamping device 100 includes a mold space adjustment mechanism 180. The mold space adjustment mechanism 180 adjusts the interval L between the stationary platen 110 and the toggle support 130 to adjust a mold space. A timing when a mold space is adjusted is, for example, between the end of a molding cycle and the start of the next molding cycle. The mold space adjustment mechanism 180 includes, for example, screw shafts 181 that are formed at rear end portions of the tie bars 140, screw nuts 182 that are rotatably held by the toggle support 130 not to be capable of advancing and retreating, and a mold space adjustment motor 183 that rotates the screw nuts 182 screwed to the screw shafts 181.

The screw shaft 181 and the screw nut 182 are provided for each tie bar 140. A rotational driving force of the mold space adjustment motor 183 may be transmitted to a plurality of screw nuts 182 via a rotational driving force transmission unit 185. The plurality of screw nuts 182 can be rotated in synchronization. It is also possible to individually rotate the plurality of screw nuts 182 by changing a transmission channel of the rotational driving force transmission unit 185.

The rotational driving force transmission unit 185 includes, for example, gears and the like. In this case, a driven gear is formed on an outer periphery of each screw nut 182, a driving gear is attached to an output shaft of the mold space adjustment motor 183, and an intermediate gear, which meshes with a plurality of driven gears and a plurality of driving gears, is rotatably held at a central portion of the toggle support 130. The rotational driving force transmission unit 185 may include a belt, pulleys, and the like instead of the gears.

The operation of the mold space adjustment mechanism 180 is controlled by the control device 700. The control device 700 drives the mold space adjustment motor 183 to rotate the screw nuts 182. As a result, the position of the toggle support 130 with respect to the tie bars 140 is adjusted, so that the interval L between the stationary platen 110 and the toggle support 130 is adjusted. A plurality of mold space adjustment mechanisms may be used in combination.

The interval L is measured using a mold space adjustment motor encoder 184. The mold space adjustment motor encoder 184 measures an amount of rotation and a rotation direction of the mold space adjustment motor 183, and sends signals indicating the detection results thereof to the control device 700. The detection results of the mold space adjustment motor encoder 184 are used for the monitoring and control of the position of the toggle support 130 and the interval L. A toggle support position detector for measuring the position of the toggle support 130 and an interval detector for measuring the interval L are not limited to the mold space adjustment motor encoder 184, and general detectors can be used.

The mold clamping device 100 may include a mold temperature controller that adjusts the temperature of the mold device 800. The mold device 800 includes a flow channel for a temperature control medium therein. The mold temperature controller adjusts the temperature of a temperature control medium, which is supplied to the flow channel of the mold device 800, to adjust the temperature of the mold device 800.

The mold clamping device 100 of the present embodiment is a horizontal type in which a mold opening/closing direction is a horizontal direction, but may be a vertical type in which a mold opening/closing direction is a vertical direction.

The mold clamping device 100 of the present embodiment includes the mold clamping motor 160 as a drive unit, but may include a hydraulic cylinder instead of the mold clamping motor 160. Further, the mold clamping device 100 may include a linear motor for opening and closing the mold and may include an electromagnet for clamping the mold.

### Ejector Device

In the description of the ejector device 200, as in the description of the mold clamping device 100, the moving direction of the movable platen 120 in a case where the mold is to be closed (for example, the X-axis positive direction) will correspond to a front, and the moving direction of the movable platen 120 in a case where the mold is to be opened (for example, the X-axis negative direction) will correspond to a rear.

The ejector device 200 is attached to the movable platen 120, and advances and retreats together with the movable platen 120. The ejector device 200 includes ejector rods 210 that eject the molding products from the mold device 800, and a drive mechanism 220 that moves the ejector rods 210 in the moving direction of the movable platen 120 (X-axis direction).

The ejector rods 210 are disposed in through-holes of the movable platen 120 to be capable of advancing and retreating. Front end portions of the ejector rods 210 are in contact with an ejector plate 826 of the movable mold 820. The front end portions of the ejector rods 210 may be connected to or may not be connected to the ejector plate 826.

The drive mechanism 220 includes, for example, an ejector motor, and a motion conversion mechanism that converts a rotary motion of the ejector motor into a linear motion of the ejector rod 210. The motion conversion mechanism includes a screw shaft and a screw nut that is screwed to the screw shaft. Balls or rollers may be interposed between the screw shaft and the screw nut.

The ejector device 200 performs an ejection process under the control of the control device 700. In the ejection process, the ejector rods 210 are caused to advance up to an ejection position from a standby position at a set movement speed, so that the ejector plate 826 is caused to advance to eject the molding products. After that, the ejector motor is driven to cause the ejector rods 210 to retreat at a set movement speed and to cause the ejector plate 826 to retreat up to the original standby position.

The position and the movement speed of the ejector rod 210 are measured using, for example, an ejector motor encoder. The ejector motor encoder measures the rotation of the ejector motor, and sends a signal indicating the detection result thereof to the control device 700. An ejector rod position detector for measuring the position of the ejector rod 210 and an ejector rod movement speed detector for measuring the movement speed of the ejector rod 210 are not limited to the ejector motor encoder, and general detectors can be used.

### Injection Device

In the description of the injection device 300, unlike in the description of the mold clamping device 100 and the description of the ejector device 200, a moving direction of a screw 330 during filling (for example, the X-axis negative direction) will correspond to a front, and a moving direction of the screw 330 during metering (for example, the X-axis positive direction) will correspond to a rear.

The injection device 300 is installed on a slide base 301, and the slide base 301 is disposed to be capable of advancing and retreating with respect to the injection device frame 920. The injection device 300 is disposed to be capable of advancing and retreating with respect to the mold device 800. The injection device 300 touches the mold device 800, and fills the cavity spaces 801 formed in the mold device 800 with a molding material. The injection device 300 includes, for example, a cylinder 310 that heats the molding material, a nozzle 320 that is provided at a front end portion of the cylinder 310, the screw 330 that is disposed in the cylinder 310 to be capable of advancing and retreating and to be rotatable, a metering motor 340 that rotates the screw 330, an injection motor 350 that causes the screw 330 to advance and retreat, and a load detector 360 that measures a load transmitted between the injection motor 350 and the screw 330.

The cylinder 310 heats the molding material fed from a feed port 311 to the inside. The molding material includes, for example, a resin and the like. The molding material is formed in the shape of, for example, pellets and is fed to the feed port 311 in a solid state. The feed port 311 is formed at a rear portion of the cylinder 310. A cooler 312, such as a water cooling cylinder, is provided on an outer periphery of the rear portion of the cylinder 310. Heating units 313, such as band heaters, and temperature detectors 314 are provided on the outer periphery of the cylinder 310 in front of the cooler 312.

The cylinder 310 is divided into a plurality of zones in an axial direction of the cylinder 310 (for example, the X-axis direction). The heating unit 313 and the temperature detector 314 are provided in each of the plurality of zones. A set temperature is set in each of the plurality of zones, and the control device 700 controls the heating units 313 such that temperatures measured by the temperature detectors 314 reach the set temperatures.

An example in which the cylinder 310 and the nozzle 320 are divided into five zones (zones Z1 to Z5) in the axial direction of the cylinder 310 (for example, the X-axis direction) will be described in the present embodiment. The division in the present embodiment is described as one example, and the number of divided zones may be three or less or six or more.

The nozzle 320 is provided at the front end portion of the cylinder 310, and is pressed against the mold device 800. A heating unit 313 and a temperature detector 314 are provided on an outer periphery of the nozzle 320. The control device 700 controls the heating unit 313 such that the measured temperature of the nozzle 320 reaches a set temperature.

The screw 330 is disposed in the cylinder 310 to be capable of advancing and retreating and to be rotatable. In a case where the screw 330 is rotated, a molding material is fed forward along a helical groove of the screw 330. The molding material is gradually melted by heat from the cylinder 310 while being fed forward. As the liquid molding material is fed in front of the screw 330 and is accumulated in the front portion of the cylinder 310, the screw 330 is caused to retreat. After that, in a case where the screw 330 is caused to advance, the liquid molding material accumulated in front of the screw 330 is injected from the nozzle 320 and the mold device 800 is filled with the molding material.

A backflow prevention ring 331 is attached to a front portion of the screw 330 to be capable of advancing and retreating as a backflow prevention valve that prevents the backflow of the molding material flowing rearward from the front of the screw 330 in a case where the screw 330 is pushed forward.

In a case where the screw 330 is caused to advance, the backflow prevention ring 331 is pushed rearward by the pressure of the molding material accumulated in front of the screw 330 and retreats relative to the screw 330 up to a close position (see FIG. 2) where the flow channel for a molding material is closed. Accordingly, the molding material accumulated in front of the screw 330 is prevented from flowing back to the rear.

On the other hand, in a case where the screw 330 is rotated, the backflow prevention ring 331 is pushed forward by the pressure of the molding material fed forward along the helical groove of the screw 330 and advances relative to the screw 330 up to an open position (see FIG. 1) where the flow channel for a molding material is opened. Accordingly, the molding material is fed in front of the screw 330.

The backflow prevention ring 331 may be either a co-rotation type that is rotated together with the screw 330 or a non-co-rotation type that is not rotated together with the screw 330.

The injection device 300 may include a drive source that causes the backflow prevention ring 331 to advance and retreat with respect to the screw 330 between the open position and the close position.

The metering motor 340 rotates the screw 330. A drive source that rotates the screw 330 is not limited to the metering motor 340, and may be, for example, a hydraulic pump or the like.

The injection motor 350 causes the screw 330 to advance and retreat. A motion conversion mechanism that converts a rotary motion of the injection motor 350 into a linear motion of the screw 330, and the like are provided between the injection motor 350 and the screw 330. The motion conversion mechanism includes, for example, a screw shaft and a screw nut that is screwed to the screw shaft. Balls, rollers, or the like may be provided between the screw shaft and the screw nut. A drive source that causes the screw 330 to advance and retreat is not limited to the injection motor 350, and may be, for example, a hydraulic cylinder or the like.

The load detector 360 measures a load that is transmitted between the injection motor 350 and the screw 330. The measured load is converted into a pressure by the control device 700. The load detector 360 is provided in a transmission channel for a load between the injection motor 350 and the screw 330, and measures a load that acts on the load detector 360.

The load detector 360 sends a signal of the measured load to the control device 700. The load measured by the load detector 360 is converted into a pressure that acts between the screw 330 and the molding material, and is used for the control and monitoring of a pressure that is received by the screw 330 from the molding material, a back pressure that acts on the screw 330, a pressure that acts on the molding material from the screw 330, and the like.

A pressure detector that measures the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed in the mold device 800.

The injection device 300 performs a metering process, a filling process, a holding pressure process, and the like under the control of the control device 700. The filling process and the holding pressure process may also be collectively referred to as an injection process.

In the metering process, the metering motor 340 is driven to rotate the screw 330 at a set rotating speed to feed the molding material forward along the helical groove of the screw 330. Accordingly, the molding material is gradually melted. As the liquid molding material is fed in front of the screw 330 and is accumulated in the front portion of the cylinder 310, the screw 330 is caused to retreat. A rotating speed of the screw 330 is measured using, for example, a metering motor encoder 341. The metering motor encoder 341 measures the rotation of the metering motor 340 and sends a signal indicating the detection result thereof to the control device 700. A screw rotating speed detector that measures the rotating speed of the screw 330 is not limited to the metering motor encoder 341, and a general detector can be used.

In the metering process, the injection motor 350 may be driven to apply a set-back pressure to the screw 330 to limit the sudden retreat of the screw 330. The back pressure applied to the screw 330 is measured using, for example, the load detector 360. In a case where the screw 330 retreats up to a metering completion position and a predetermined amount of molding material is accumulated in front of the screw 330, the metering process is completed.

Positions and rotating speeds of the screw 330 in the metering process are collectively set as a series of set conditions. For example, a metering start position, a rotating speed switching position, and a metering completion position are set. These positions are arranged in this order from the front side toward the rear, and indicate starting points and end points of sections in which the rotating speeds are set. The rotating speed is set for each section. One rotating speed switching position may be set, or a plurality of rotating speed switching positions may be set. The rotating speed switching position may not be set. Further, a back pressure is set for each section.

In the filling process, the injection motor 350 is driven to cause the screw 330 to advance at a set movement speed and to fill the cavity spaces 801 formed in the mold device 800 with the liquid molding material accumulated in front of the screw 330. The position and movement speed of the screw 330 are detected using, for example, an injection motor encoder 351. The injection motor encoder 351 measures the rotation of the injection motor 350 and sends a signal indicating the detection result thereof to the control device 700. In a case where the position of the screw 330 reaches a set position, the switching of the filling process to the holding pressure process (so-called V/P switching) is performed. A position where V/P switching is performed is also referred to as a V/P switching position. The set movement speed of the screw 330 may be changed depending on the position of the screw 330, a time, or the like.

Positions and movement speeds of the screw 330 in the filling process are collectively set as a series of set conditions. For example, a filling start position (also referred to as an “injection start position”), a movement speed switching position, and a V/P switching position are set. These positions are arranged in this order from the rear side toward the front, and indicate starting points and end points of sections in which the movement speeds are set. The movement speed is set for each section. One movement speed switching position may be set, or a plurality of movement speed switching positions may be set. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a set pressure, the screw 330 advances at a set movement speed. On the other hand, in a case where the pressure of the screw 330 exceeds the set pressure, the screw 330 advances at a movement speed lower than the set movement speed so that the pressure of the screw 330 is equal to or lower than the set pressure for the purpose of protecting the mold.

After the position of the screw 330 reaches the V/P switching position in the filling process, the screw 330 may be caused to temporarily stop, and the V/P switching may be then performed. Immediately before the V/P switching, instead of stopping the screw 330, the screw 330 may advance at a very low speed or retreat at a very low speed. Further, a screw position detector for measuring the position of the screw 330 and a screw movement speed detector for measuring the movement speed of the screw 330 are not limited to the injection motor encoder 351, and general detectors can be used.

In the holding pressure process, the injection motor 350 is driven to push the screw 330 forward to maintain the pressure of the molding material at a front end portion of the screw 330 (hereinafter, also referred to as a “holding pressure”) at a set pressure and to push a molding material remaining in the cylinder 310 toward the mold device 800. A molding material which is insufficient due to cooling contraction in the mold device 800 can be replenished. The holding pressure is measured using, for example, the load detector 360. A set value of the holding pressure may be changed depending on a time that has passed from the start of the holding pressure process, or the like. A plurality of holding pressures and a plurality of holding times in which the holding pressure is held in the holding pressure process may be set, and may be collectively set as a series of set conditions.

The molding material, with which the cavity spaces 801 formed in the mold device 800 is filled, is gradually cooled in the holding pressure process, and an inlet of the cavity spaces 801 is closed by the solidified molding material at the time of completion of the holding pressure process. This state is referred to as a gate seal, and the backflow of the molding material from the cavity spaces 801 is prevented. A cooling process is started after the holding pressure process. The molding material in the cavity spaces 801 is solidified in the cooling process. The metering process may be performed in the cooling process for the purpose of shortening a molding cycle time.

The injection device 300 of the present embodiment is an in-line screw type, but may be a pre-plasticizing type or the like. A pre-plasticizing type injection device feeds a molding material, which is melted in a plasticizing cylinder, to an injection cylinder and injects the molding material into a mold device from the injection cylinder. A screw is disposed in the plasticizing cylinder to be rotatable and not to be capable of advancing and retreating, or a screw is disposed in the plasticizing cylinder to be rotatable and to be capable of advancing and retreating. Meanwhile, a plunger is disposed in the injection cylinder to be capable of advancing and retreating.

Further, the injection device 300 of the present embodiment is a horizontal type in which the axial direction of the cylinder 310 is a horizontal direction, but may be a vertical type in which the axial direction of the cylinder 310 is a vertical direction. A mold clamping device to be combined with a vertical type injection device 300 may be a vertical type or a horizontal type. Likewise, a mold clamping device to be combined with a horizontal type injection device 300 may be a horizontal type or a vertical type.

### Moving Device

In the description of the moving device 400, as in the description of the injection device 300, the moving direction of the screw 330 during filling (for example, the X-axis negative direction) will correspond to a front, and the moving direction of the screw 330 during metering (for example, the X-axis positive direction) will correspond to a rear.

The moving device 400 causes the injection device 300 to advance and retreat with respect to the mold device 800. Further, the moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 includes a first port 411 and a second port 412. The hydraulic pump 410 is a pump that can be rotated in both directions, and sucks hydraulic fluid (for example, oil) from any one of the first port 411 and the second port 412 and discharges the hydraulic fluid from the other thereof to generate hydraulic pressure in a case where a rotation direction of the motor 420 is changed. The hydraulic pump 410 can also suck hydraulic fluid from a tank and discharge the hydraulic fluid from any one of the first port 411 and the second port 412.

The motor 420 causes the hydraulic pump 410 to operate. The motor 420 drives the hydraulic pump 410 in a rotation direction, which corresponds to a control signal sent from the control device 700, with rotation torque corresponding to the control signal. The motor 420 may be an electric motor or may be an electric servomotor.

The hydraulic cylinder 430 includes a cylinder body 431, a piston 432, and a piston rod 433. The cylinder body 431 is fixed to the injection device 300. The piston 432 partitions the inside of the cylinder body 431 into a front chamber 435 as a first chamber and a rear chamber 436 as a second chamber. The piston rod 433 is fixed to the stationary platen 110.

The front chamber 435 of the hydraulic cylinder 430 is connected to the first port 411 of the hydraulic pump 410 via a first flow channel 401. In a case where hydraulic fluid discharged from the first port 411 is supplied to the front chamber 435 via the first flow channel 401, the injection device 300 is pushed forward. The injection device 300 advances, so that the nozzle 320 is pressed against the stationary mold 810. The front chamber 435 functions as a pressure chamber that generates the nozzle touch pressure of the nozzle 320 with the pressure of the hydraulic fluid supplied from the hydraulic pump 410.

On the other hand, the rear chamber 436 of the hydraulic cylinder 430 is connected to the second port 412 of the hydraulic pump 410 via a second flow channel 402. In a case where hydraulic fluid discharged from the second port 412 is supplied to the rear chamber 436 of the hydraulic cylinder 430 via the second flow channel 402, the injection device 300 is pushed rearward. The injection device 300 retreats, so that the nozzle 320 is separated from the stationary mold 810.

The moving device 400 includes the hydraulic cylinder 430 in the present embodiment, but the present invention is not limited thereto. For example, an electric motor and a motion conversion mechanism that converts a rotary motion of the electric motor into a linear motion of the injection device 300 may be used instead of the hydraulic cylinder 430.

### Control Device

The control device 700 is formed of, for example, a computer and includes a control circuit 701, a storage medium 702, such as a memory, an input interface 703, and an output interface 704 as shown in FIGS. 1 and 2. The control circuit 701 may be a central processing unit (CPU) or may be a hardware-connected circuit. For example, the control device 700 causes a CPU, which is provided as the control circuit 701, to execute a program, which is stored in the storage medium 702, to perform various types of control. Further, the control device 700 receives a signal from the outside through the input interface 703, and transmits a signal to the outside through the output interface 704.

The control device 700 repeatedly performs the metering process, the mold closing process, the pressurization process, the mold clamping process, the filling process, the holding pressure process, the cooling process, the depressurization process, the mold opening process, the ejection process, and the like to repeatedly manufacture molding products. A series of operations for obtaining molding products, for example, operations from the start of a metering process to the start of the next metering process are also referred to as a “shot” or a “molding cycle”. Further, a time required for one shot is also referred to as a “molding cycle time” or a “cycle time”.

One molding cycle includes, for example, the metering process, the mold closing process, the pressurization process, the mold clamping process, the filling process, the holding pressure process, the cooling process, the depressurization process, the mold opening process, and the ejection process in this order. The order mentioned here is an order in which the respective processes are started. The filling process, the holding pressure process, and the cooling process are performed during the mold clamping process. The start of the mold clamping process may coincide with the start of the filling process. The completion of the depressurization process may coincide with the start of the mold opening process.

A plurality of processes may be simultaneously performed for the purpose of shortening a molding cycle time. For example, a metering process may be performed during a cooling process of a previous molding cycle, or may be performed during a mold clamping process. In this case, the mold closing process may be performed at the beginning of the molding cycle. Further, the filling process may be started during the mold closing process. Furthermore, the ejection process may be started during the mold opening process. In a case where an on-off valve for opening and closing a flow channel of the nozzle 320 is provided, the mold opening process may be started during the metering process. The reason for this is that a molding material does not leak from the nozzle 320 as long as the on-off valve closes the flow channel of the nozzle 320 even though the mold opening process is started during the metering process.

One molding cycle may include processes other than the metering process, the mold closing process, the pressurization process, the mold clamping process, the filling process, the holding pressure process, the cooling process, the depressurization process, the mold opening process, and the ejection process.

For example, a pre-metering suck-back process for causing the screw 330 to retreat up to a preset metering start position may be performed before the start of the metering process after the completion of the holding pressure process. Since the pressure of the molding material accumulated in front of the screw 330 can be reduced before the start of the metering process, the sudden retreat of the screw 330 at the time of start of the metering process can be prevented.

Further, a post-metering suck-back process for causing the screw 330 to retreat up to a preset filling start position (also referred to as an “injection start position”) may be performed before the start of the filling process after the completion of the metering process. Since the pressure of the molding material accumulated in front of the screw 330 can be reduced before the start of the filling process, the leakage of the molding material from the nozzle 320 before the start of the filling process can be prevented.

The control device 700 is connected to an operation device 750 that receives an input operation performed by a user and to a display device 760 that displays a screen. The operation device 750 and the display device 760 may be formed of, for example, a touch panel 770 and may be integrated with each other. The touch panel 770 as the display device 760 displays a screen under the control of the control device 700. For example, information, such as the settings of the injection molding machine 10 and the current state of the injection molding machine 10, is displayed on the screen of the touch panel 770. Further, for example, operation sections, such as buttons or input fields used to receive an input operation performed by a user, may be displayed on the screen of the touch panel 770. The touch panel 770 as the operation device 750 detects an input operation performed on the screen by a user, and outputs a signal corresponding to the input operation to the control device 700. Accordingly, for example, a user can operate the operation section provided on the screen to set the injection molding machine 10 (including the input of a set value) while checking information displayed on the screen. Further, a user can operate the operation section provided on the screen to cause the operation of the injection molding machine 10, which corresponds to the operation section, to be performed. The operation of the injection molding machine 10 may be, for example, the operation (also including stopping) of the mold clamping device 100, the ejector device 200, the injection device 300, the moving device 400, or the like. Further, the operation of the injection molding machine 10 may be the switching of the screen that is displayed on the touch panel 770 as the display device 760, or the like.

The operation device 750 and the display device 760 of the present embodiment have been described as being integrated as the touch panel 770, but may be provided independently of each other. Further, a plurality of operation devices 750 may be provided. The operation device 750 and the display device 760 are disposed on an operation side (Y-axis negative direction) of the mold clamping device 100 (more specifically, the stationary platen 110).

FIG. 3 is a diagram illustrating a disposition around a temperature sensor of the present embodiment that is used to measure a temperature of the molding material in the cavity spaces 801 provided in the mold device 800.

In the present embodiment, the cylinder 310 and the nozzle 320 are divided into five zones, that is, the zones Z1 to Z5. In the example shown in FIG. 3, the nozzle 320 is divided as the zone Z5. Further, the nozzle 320 is provided with a heating unit 313-5 for a zone Z5 (an example of a nozzle heating unit) and a temperature detector 314-5 for a zone Z5 (an example of a nozzle temperature measurement unit).

Furthermore, the zone Z4 of the cylinder 310 is provided with a heating unit 313-4 for a zone Z4 and a temperature detector 314-4 for a zone Z4 (an example of a cylinder temperature measurement unit). The zone Z3 of the cylinder 310 is provided with a heating unit 313-3 for a zone Z3 and a temperature detector 314-3 for a zone Z3 (an example of a cylinder temperature measurement unit). The zone Z2 of the cylinder 310 is provided with a heating unit 313-2 for a zone Z2 and a temperature detector 314-2 for a zone Z2 (an example of a cylinder temperature measurement unit). Likewise, the zone Z1 of the cylinder 310 is also provided with a heating unit 313-1 for a zone Z1 and a temperature detector 314-1 for a zone Z1 (an example of a cylinder temperature measurement unit).

The surface temperature measurement sensor 861 (an example of an in-mold temperature measurement unit) measures the temperature of the molding material in the mold device 800. The surface temperature measurement sensor 861 is designed to withstand the temperature rise control of the mold device 800 and the pressure of the molding material in the cavity spaces 801. As shown in FIG. 3, the surface temperature measurement sensor 861 is provided to measure the temperature of the molding material in the cavity spaces 801 from the ejector plate 826.

The temperature measurer 862 calculates the measured temperature of the molding material from a signal, which is input from the surface temperature measurement sensor 861, and outputs the measured temperature to the control device 700. The surface temperature measurement sensor 861 and the temperature measurer 862 are connected to each other by the conversion cable 863. The conversion cable 863 shown in the present embodiment is provided to pass through a passage provided in the ejector plate 826.

Further, the control device 700 of the present embodiment controls the temperature of the nozzle 320 using the heating unit 313-5 for a zone Z5 on the basis of the measured temperature of the nozzle 320 that is measured by the temperature detector 314-5 for a zone Z5 (an example of a measured nozzle temperature) and the measured temperature of the molding material that is measured by the surface temperature measurement sensor 861 (an example of a measured in-mold temperature). In the present embodiment, the temperature of the nozzle is controlled also in consideration of a measured value of the temperature of the molding material in the cavity spaces 801. Accordingly, the control device 700 of the present embodiment can suppress a variation in the temperature of the molding material in the mold device 800 to improve the stability of the molding of molding products, so that more appropriate temperature control can be realized.

FIG. 3 shows an example of the installation of the surface temperature measurement sensor 861, the temperature measurer 862, and the conversion cable 863, and the surface temperature measurement sensor 861, the temperature measurer 862, and the conversion cable 863 need only be disposed to be capable of acquiring the temperature of the molding material in the mold device 800.

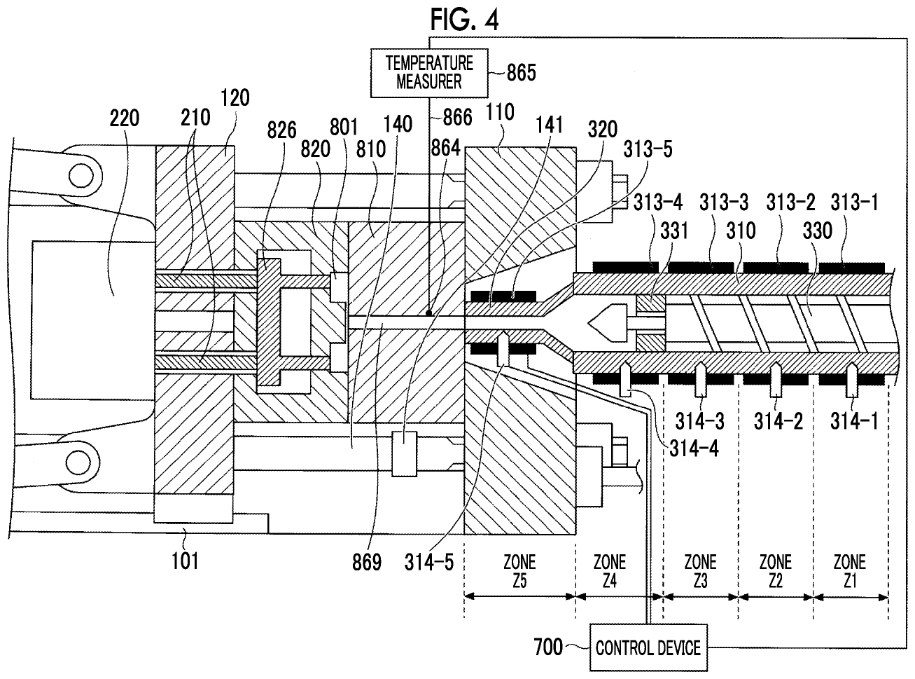

FIG. 4 is a diagram illustrating a disposition around a temperature sensor of a modification example of the present embodiment that is used to measure a temperature of the molding material on a flow channel provided in the mold device 800.

In the present modification example as well, the cylinder 310 and the nozzle 320 are divided into five zones, that is, zones Z1 to Z5. The nozzle 320 divided as the zone Z5 is provided with a heating unit 313-5 for a zone Z5 and a temperature detector 314-5 for a zone Z5 (an example of a nozzle temperature measurement unit). The cylinder 310 is provided with heating units 313-1 to 313-4 and temperature detectors 314-1 to 314-4 in the zones (zones Z1 to Z4), respectively.

A surface temperature measurement sensor 864 (an example of an in-mold temperature measurement unit) is provided to measure a temperature of a molding material in a flow channel 869, which guides the molding material to the cavity spaces 801 from the stationary mold 810, as the temperature of the molding material in the mold device 800.

A temperature measurer 865 calculates the measured temperature of the molding material from a signal, which is input from the surface temperature measurement sensor 864, and outputs the measured temperature to the control device 700. The surface temperature measurement sensor 864 and the temperature measurer 865 are connected to each other by a conversion cable 866. The conversion cable 866 shown in the present modification example is provided to pass through a passage provided in the stationary mold 810.

Further, the control device 700 of the present modification example controls the temperature of the nozzle 320 using the heating unit 313-5 for a zone Z5 on the basis of the measured temperature of the nozzle 320 that is measured by the temperature detector 314-5 for a zone Z5 (an example of a measured nozzle temperature) and the measured temperature of the molding material that is measured by the surface temperature measurement sensor 864 (an example of a measured in-mold temperature). Since the surface temperature measurement sensor 864 is provided on the flow channel of the mold device 800 in the present modification example, the surface temperature measurement sensor 864 is easily disposed. Further, since a position where the surface temperature measurement sensor 864 is disposed is not in the cavity space 801, the influence of the surface temperature measurement sensor 864 on a molding product can be suppressed.

As described above, the surface temperature measurement sensor for measuring the temperature of the molding material need only be disposed to be capable of measuring the temperature of the molding material in the mold device 800. In addition, the surface temperature measurement sensor is not limited to a method of directly measuring the temperature of the molding material in the mold device 800, and may acquire the measured temperature of the mold device 800 near the molding material as the measured temperature of the molding material or may acquire the temperature of the molding material transmitted via the mold device 800.

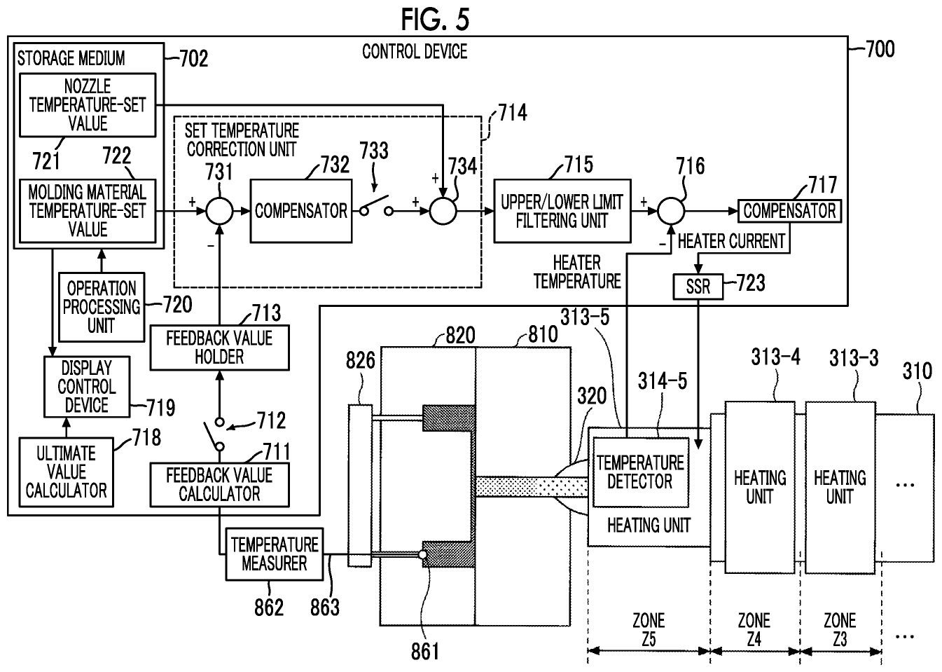

FIG. 5 is a diagram showing a configuration example of the control device 700 of the present embodiment. The configuration shown in FIG. 5 may be realized using hardware connection, may be realized using software control, or may be realized using a combination of hardware connection and software control.

As shown in FIG. 5, the control device 700 includes a feedback value calculator 711, an update switch 712, a feedback value holder 713, a set temperature correction unit 714, an upper/lower limit filtering unit 715, a calculator 716, a compensator 717, an ultimate value calculator 718, a display control device 719, an operation processing unit 720, and a solid state relay 723. Further, the storage medium 702 stores a nozzle temperature-set value 721 and a molding material temperature-set value 722. The set temperature correction unit 714 includes a calculator 731, a compensator 732, a correction changeover switch 733, and an adder 734 as components that correct the nozzle temperature-set value 721 on the basis of the measured temperature measured by the surface temperature measurement sensor 861.

The nozzle temperature-set value 721 is a value that is set by a user, and is a target temperature that is set to control the heating unit 313-5 provided on the nozzle 320. The molding material temperature-set value 722 is a value that is set by a user, and is a target temperature that is set for the molding material in the mold device 800.

The display control device 719 performs a control to display a screen of the display device 760. The operation processing unit 720 processes operation information input from the operation device 750.

The feedback value calculator (an example of a calculation unit) 711 calculates a feedback value, which is used to correct the molding material temperature-set value 722, on the basis of the temperature of the molding material in the mold device 800 that is measured by the temperature measurer 862. The feedback value will be described later.

The update switch 712 is a switch that is turned on at a timing when a feedback value (an example of a correction value) is calculated by the feedback value calculator 711.

The feedback value holder (an example of a holding unit) 713 is a holder that holds a feedback value used to correct the nozzle temperature-set value 721. The feedback value held in the feedback value holder 713 is updated to the feedback value calculated by the feedback value calculator 711 at a timing when the update switch 712 is turned on.

The set temperature correction unit 714 corrects the nozzle temperature-set value 721, which is set as a target of the nozzle 320, on the basis of a difference between the molding material temperature-set value 722 and the feedback value that is held in the feedback value holder 713. As described above, the feedback value is a value calculated on the basis of the temperature of the molding material in the mold device 800 that is measured by the temperature measurer 862.

Before the description of a specific feedback value, the temperature of the molding material in the mold device 800 will be described.

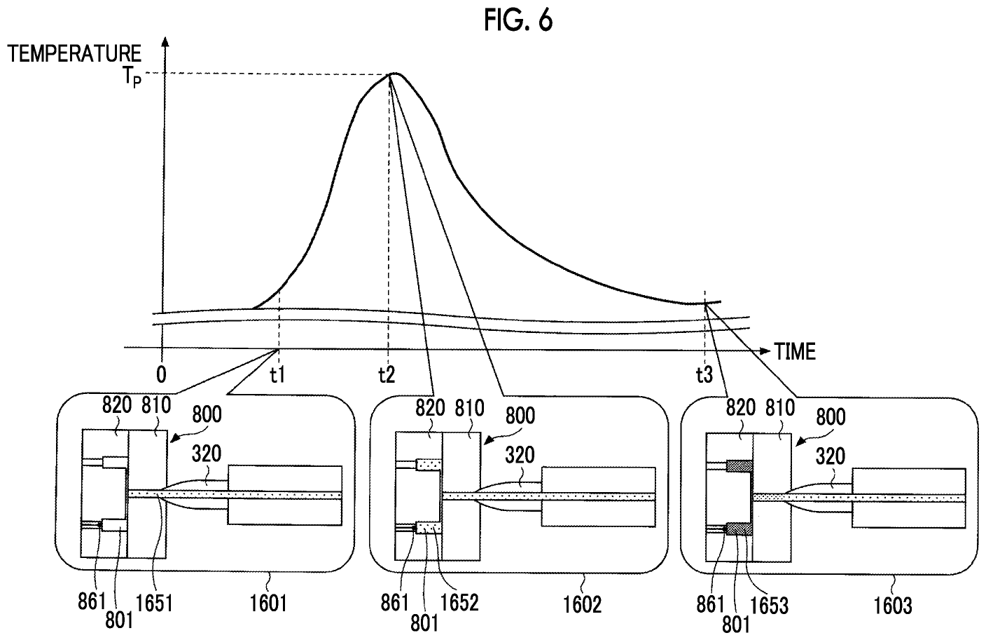

FIG. 6 is a diagram illustrating a change in the temperature that is measured by the surface temperature measurement sensor 861 in a case where the mold device 800 is filled with a molding material. In the example shown in FIG. 6, a horizontal axis is a time axis and a vertical axis represents a temperature. A time “0” indicates the start of filling.

Further, near a time “t1”, the mold device 800 starts to be filled with a molding material 1651 from the nozzle 320 as shown in a frame 1601. Accordingly, the surface temperature measurement sensor 861 detects a temperature rise that is caused by heat starting to be transferred to the mold device 800.

After that, near a time “t2”, since the cavity spaces 801 of the mold device 800 are filled with a molding material 1652 as shown in a frame 1602, the surface temperature measurement sensor 861 directly measures the temperature of the melted molding material. Then, immediately after the cavity spaces 801 of the mold device 800 are completely filled with the molding material, the surface temperature measurement sensor 861 measures a maximum value “Tp” of the temperature. After that, the temperature of the molding material is gradually lowered.

Then, near a time “t3”, the surface temperature measurement sensor 861 measures the temperature of the cooled molding material as shown in a frame 1603.

As described above, the measured temperature of the molding material in the cavity spaces 801 of the mold device 800 is changed with the passage of time. For this reason, it is necessary to set a reference of the measured temperature to measure a change in the temperature of the molding material in the mold device 800 that is caused by disturbance. Accordingly, any one of the maximum value, an average value, and an inclination of the temperature of the molding material is used as the reference of the measured temperature in the present embodiment. For example, an individual difference in the temperature control of the mold device 800, outside air, an individual difference in the shape or the like of the flow channel of the mold device 800, the position of the temperature detector 314-5 (a method of inserting a thermocouple that is the temperature detector 314-5), and the like are conceivable as the disturbance.

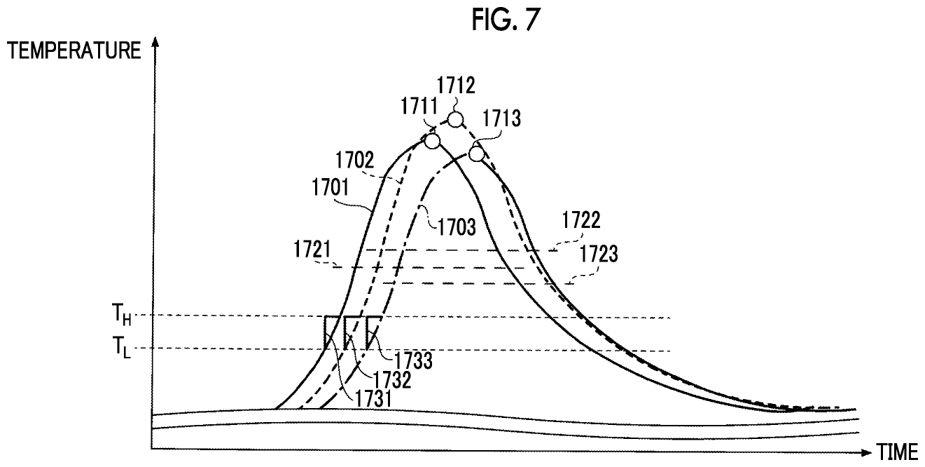

FIG. 7 is a diagram illustrating a change in the temperature that is measured by the surface temperature measurement sensor 861 for each shot of a molding material with which the mold device 800 is filled. In the example shown in FIG. 7, a horizontal axis is a time axis and a vertical axis represents a temperature. A temperature change 1701 corresponds to a first shot, a temperature change 1702 corresponds to a second shot, and a temperature change 1703 corresponds to a third shot. FIG. 7 shows an example in which temporal changes of three shots are collectively shown. Further, FIG. 7 shows an example in which temperature changes for the respective shots are shifted from each other in the direction of the horizontal axis so that a difference between the temporal changes of the respective shots is easily ascertained.

For example, in a case where a maximum value of the temperature of the molding material is used, a target value representing the maximum value of the temperature of the molding material is set as the molding material temperature-set value 722 of the storage medium 702. Then, the feedback value calculator 711 calculates a maximum value 1711 of the measured temperature of the temperature change 1701 of the first shot as a feedback value. After that, in the first shot, the set temperature correction unit 714 corrects the nozzle temperature-set value 721 on the basis of a difference between the molding material temperature-set value 722 and the maximum value 1711 of the first shot (feedback value).

Likewise, in the second shot, the feedback value calculator 711 calculates a maximum value 1712 of the measured temperature of the temperature change 1702 of the second shot as a feedback value, and the set temperature correction unit 714 corrects the nozzle temperature-set value 721 on the basis of a difference between the molding material temperature-set value 722 and the maximum value 1712 of the second shot (feedback value). In the third shot as well, a maximum value 1713 of the measured temperature of the temperature change 1703 of the third shot is calculated as a feedback value, and the same processing is then performed.

As another example, in a case where an average value of the temperature of the molding material is used, a target value representing the average value of the temperature of the molding material is set as the molding material temperature-set value 722 of the storage medium 702. Then, the feedback value calculator 711 calculates an average value 1721 of the measured temperature of the temperature change 1701 of the first shot as a feedback value. A period until a cooling completion time from the detection of a temperature rise of each shot is conceivable as a period used to calculate the average value, but the period used to calculate the average value may be set depending on an embodiment. After that, in the first shot, the set temperature correction unit 714 corrects the nozzle temperature-set value 721 on the basis of a difference between the molding material temperature-set value 722 and the average value 1721 of the first shot (feedback value).

Likewise, in the second shot, the feedback value calculator 711 calculates an average value 1722 of the measured temperature of the temperature change 1702 of the second shot as a feedback value. Then, the set temperature correction unit 714 corrects the nozzle temperature-set value 721 on the basis of a difference between the molding material temperature-set value 722 and the average value 1722 of the second shot (feedback value). In the third shot as well, an average value 1723 of the measured temperature of the temperature change 1703 of the third shot is calculated as a feedback value, and the same processing is then performed.

As still another example, in a case where an inclination of the temperature of the molding material is used, a target value representing the maximum value of the temperature of the molding material is set as the molding material temperature-set value 722 of the storage medium 702. Then, the feedback value calculator 711 calculates an inclination 1731 of the temperature on the basis of a time until a first reference temperature TL reaches a second reference temperature TH during the temperature change 1701 of the first shot. The first reference temperature TL and the second reference temperature TH are preset temperatures, and are determined depending on an embodiment, such as a melting point of the molding material.

In addition, the feedback value calculator 711 estimates the maximum value of the temperature of the molding material from the inclination 1731 of the temperature of the molding material as a feedback value. Any method may be used as a method of estimating the maximum value of the temperature from the inclination of the temperature, and a maximum value may be calculated using a mathematical model representing a temperature change, or a maximum value may be acquired from a correspondence relationship between the inclination of the temperature and the maximum value of the temperature.

Then, the set temperature correction unit 714 corrects the nozzle temperature-set value 721 on the basis of a difference between the molding material temperature-set value 722 and the maximum value of the temperature that is estimated as the first shot (feedback value).

Likewise, in the second shot, the feedback value calculator 711 calculates an inclination 1732 of the measured temperature of the temperature change 1702 of the second shot and then estimates the maximum value of the temperature from the inclination 1732 as a feedback value. Then, the set temperature correction unit 714 corrects the nozzle temperature-set value 721 on the basis of a difference between the molding material temperature-set value 722 and the maximum value that is estimated as the second shot (feedback value). In the third shot as well, an inclination 1733 of the measured temperature of the temperature change 1703 of the third shot is calculated, and the same processing is then performed.

The feedback value calculator 711 according to the present embodiment calculates a feedback value, which is used to correct the nozzle temperature-set value 721, on the basis of a temperature that is measured while the surface temperature measurement sensor 861 measures a temperature change caused by the filling of the molding material. In other words, the feedback value calculator 711 calculates a feedback value, which is used to correct the nozzle temperature-set value 721, on the basis of a temperature that is measured when the cavity spaces 801 are filled with the molding material. “When the cavity spaces 801 are filled with the molding material” indicates, for example, a time until the completion of cooling from the start of filling and may be when the molding material is present in the mold device 800. A time at which a temperature is measured, and the like can be arbitrarily set after the cavity spaces 801 are filled with the molding material.

Further, a timing when a feedback value is calculated varies depending on which one of the maximum value, the average value, and the inclination of the temperature of the molding material is used as a reference of the measured temperature. For example, in a case where the inclination is used, the feedback value calculator 711 can calculate a feedback value at a timing when a temperature measured by the surface temperature measurement sensor 861 exceeds the second reference temperature TH. Further, in a case where the maximum value is used, the feedback value calculator 711 can calculate a feedback value at a timing when a temperature measured by the surface temperature measurement sensor 861 starts to be lowered. In a case where the average value is used, the feedback value calculator 711 can calculate a feedback value at a timing when a temperature measured by the surface temperature measurement sensor 861 has been lowered (cooling is completed).

In the present embodiment, the nozzle temperature-set value 721 is corrected at a timing when a feedback value is calculated. That is, a point in time at which the correction of the nozzle temperature-set value 721 corresponding to a shot is performed is in the order of the inclination, the maximum value, and the average value. For example, in a case where the inclination is used, a correction of the nozzle temperature-set value 721 can be performed earliest. Accordingly, it is possible to quickly stabilize the temperature of the molding material in the mold device 800.

Returning to FIG. 5, the calculator 731, the compensator 732, the correction changeover switch 733, and the adder 734, which are included in the set temperature correction unit 714 as components for correcting the nozzle temperature-set value 721, will be described.

The calculator 731 subtracts the feedback value (the maximum value or the average value), which is held in the feedback value holder 713, from the molding material temperature-set value 722 (the maximum value or the average value set as a target temperature of the molding material) to calculate a difference value between the target value of the molding material and an actually measured value.

The compensator 732 performs a compensation control on the difference value that is calculated by the calculator 731. Any method may be used for the compensation control, and, for example, PID control is used.

The correction changeover switch 733 is a switch that is switched to modes relating to whether or not to correct the nozzle temperature-set value 721 according to operation information that is input from the operation device 750 via the operation processing unit 720.

The adder 734 adds the difference value, which has been subjected to the compensation control by the compensator 732, to the nozzle temperature-set value 721 in a case where the correction changeover switch 733 is switched to a mode in which the nozzle temperature-set value 721 is corrected.

That is, the adder 734 performs a control to increase the nozzle temperature-set value 721 by the difference value in a case where the feedback value (the maximum value or the average value of the temperature of the molding material of a previous shot) is smaller than the molding material temperature-set value 722 (the maximum value or the average value set as a target temperature of the molding material).

Further, the adder 734 performs a control to reduce the nozzle temperature-set value 721 by the difference value in a case where the feedback value (the maximum value or the average value of the temperature of the molding material of a previous shot) is larger than the molding material temperature-set value 722 (the maximum value or the average value set as a target temperature of the molding material).

Since the nozzle temperature-set value 721 is corrected according to the temperature of the molding material in the mold device 800 as described above, the temperature of the molding material in the mold device 800 can be controlled to be a set value. Accordingly, the temperature of the molding material can be stabilized.

The upper/lower limit filtering unit 715 determines whether or not the nozzle temperature-set value 721 corrected by the set temperature correction unit 714 is included in a predetermined temperature range. Then, in a case where the upper/lower limit filtering unit 715 determines that the nozzle temperature-set value 721 is not included in the range, the upper/lower limit filtering unit 715 changes the nozzle temperature-set value 721 so that the nozzle temperature-set value 721 is included in the range. The temperature range is set by a user on the basis of the characteristics of the molding material, and the like. For example, an upper limit temperature of the temperature range is set not to exceed a temperature at which the molding material is decomposed, and a lower limit temperature of the temperature range is set not to be lower than a temperature at which the molding material is solidified.

Since the upper/lower limit filtering unit (an example of a filter unit) 715 changes the nozzle temperature-set value 721 so that the nozzle temperature-set value 721 is included in the temperature range, an overcorrection based on an abnormal value can be suppressed, for example, even in a case where the surface temperature measurement sensor 861 measures the abnormal value.

Further, in a case where a load is applied to other components even though the surface temperature measurement sensor 861 measures an appropriate value, the upper/lower limit filtering unit 715 changes the nozzle temperature-set value 721 so that the nozzle temperature-set value 721 is included in the temperature range. As a result, the application of the load can be suppressed.

The calculator 716 subtracts the temperature of the nozzle 320, which is measured by the temperature detector 314-5 for a zone Z5, from the nozzle temperature-set value 721, which is output from the upper/lower limit filtering unit 715, to calculate a difference value that is used to adjust the heating unit 313-5 for a zone Z5.

The compensator 717 performs a compensation control on the difference value for the adjustment of the heating unit 313-5 that is calculated by the calculator 716.

The solid state relay (SSR) 723 performs a control to turn on or off the heating unit 313-5 for a zone Z5 according to the difference value that is input from the compensator 717.

Since the control device 700 has the above-mentioned configuration, the control device 700 can control the temperature of the nozzle 320 such that the measured temperature of the nozzle 320 measured by the temperature detector 314-5 for a zone Z5 reaches the nozzle temperature-set value 721 corrected by the set temperature correction unit 714.

The ultimate value calculator (an example of a number-of-shot calculation unit) 718 calculates, for example, the number of shots for filling the cavity spaces 801 with the molding material that is required until the measured temperature of the nozzle 320 measured by the temperature detector 314-5 for a zone Z5 reaches the nozzle temperature-set value 721 corrected and changed by the set temperature correction unit 714 and the upper/lower limit filtering unit 715. The ultimate value calculator 718 of the present embodiment calculates the number of shots that is required until the measured temperature of the nozzle 320 reaches the nozzle temperature-set value 721, which is output from the upper/lower limit filtering unit 715, on the basis of a temperature between a measured temperature of the nozzle 320 that is measured at the time of the previous shot, a measured temperature of the nozzle 320 that is measured at the time of the present shot, and the nozzle temperature-set value 721 that is output from the upper/lower limit filtering unit 715. For example, a temperature which rises during one shot can be specified from the measured temperature of the nozzle 320 that is measured at the time of the previous shot and from the measured temperature of the nozzle 320 that is measured at the time of the present shot. Then, the ultimate value calculator 718 calculates the number of shots from a difference between the nozzle temperature-set value 721 output from the upper/lower limit filtering unit 715 and the measured temperature of the nozzle 320 measured at the time of the present shot, and a temperature that rises during one shot. A method of calculating the number of shots is not limited to such a calculation method, and any well-known method may be used.

The ultimate value calculator 718 is not limited to calculating the number of shots that is required until the measured temperature of the nozzle 320 reaches the nozzle temperature-set value 721 corrected by the set temperature correction unit 714, and may calculate a time or a ratio (percentage) that is required until the measured temperature of the nozzle 320 reaches the nozzle temperature-set value 721.

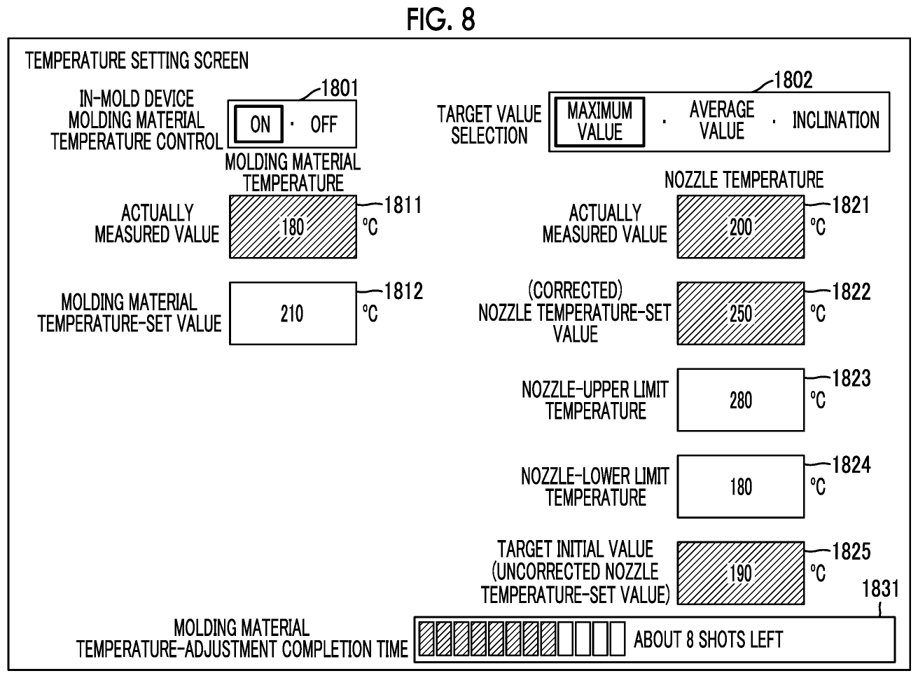

Next, a user's operation will be described. FIG. 8 is a diagram illustrating a temperature setting screen that is displayed by the display control device 719 and that is used to control the temperature of the nozzle 320. As shown in FIG. 8, an in-mold device molding material temperature control field 1801 and a target value selection field 1802 are displayed on the temperature setting screen. Further, an actually measured value field 1811 and a molding material temperature-set value field 1812 are displayed on the temperature setting screen as fields for the temperature of the molding material. Furthermore, an actually measured value field 1821, a (corrected) nozzle temperature-set value field 1822, a nozzle-upper limit temperature field 1823, a nozzle-lower limit temperature field 1824, and a target initial value (uncorrected nozzle temperature-set value) field 1825 are displayed on the temperature setting screen as fields for the temperature of the nozzle. In addition, a molding material temperature-adjustment completion time 1831 is displayed on the temperature setting screen. The operation processing unit 720 performs update processing for set values corresponding to values entered in input fields among these fields, instructs components included in the control device 700, and the like. In the example shown in FIG. 8, the hatched fields are display fields, and white fields are input fields.

“ON” and “OFF” are displayed in the in-mold device molding material temperature control field 1801 to be selectable. “ON” is a selection item for correcting the nozzle temperature-set value 721 via the set temperature correction unit 714, and “OFF” is a selection item for not correcting the nozzle temperature-set value 721 via the set temperature correction unit 714.

In a case where the operation processing unit 720 receives a selection of “OFF”, the operation processing unit 720 gives an instruction to turn off the correction changeover switch 733. In addition, the display control device 719 displays a temperature setting screen on which the molding material temperature-set value field 1812 and the (corrected) nozzle temperature-set value field 1822 are not displayed, and the target initial value (uncorrected nozzle temperature-set value) field 1825 is switched to an input field. That is, the molding material temperature-set value field 1812 used for the correction of the molding material temperature-set value 722 is not displayed, and the target initial value (uncorrected nozzle temperature-set value) field 1825 in which the nozzle temperature-set value 721 is entered is displayed.

In a case where the operation processing unit 720 receives a selection of “ON”, the operation processing unit 720 gives an instruction to turn on the correction changeover switch 733. In addition, the display control device 719 displays a temperature setting screen on which the target initial value (uncorrected nozzle temperature-set value) field 1825 is switched to a display field and a value cannot be entered in the target initial value (uncorrected nozzle temperature-set value) field 1825, the molding material temperature-set value field 1812 is displayed as an input field, and the (corrected) nozzle temperature-set value field 1822 is a display field. That is, the molding material temperature-set value field 1812 used for the correction of the nozzle temperature-set value 721 is displayed.

“Maximum value”, “average value”, and “inclination” are displayed in the target value selection field 1802 to be selectable. The operation processing unit 720 instructs the feedback value calculator 711 to calculate a feedback value according to an item selected from “maximum value”, “average value”, and “inclination”.

The actually measured value field 1811 is a display field that displays the temperature of the molding material in the mold device 800 which is calculated by the temperature measurer 862.

The molding material temperature-set value field 1812 is an input field that receives an input of the molding material temperature-set value 722 in a case where “ON” is selected in the in-mold device molding material temperature control field 1801.

The actually measured value field 1821 is a display field that displays the temperature of the nozzle 320 measured by the temperature detector 314-5 for a zone Z5.

The (corrected) nozzle temperature-set value field 1822 is a display field that displays the nozzle temperature-set value 721 corrected by the set temperature correction unit 714 in a case where “ON” is selected in the in-mold device molding material temperature control field 1801.

The nozzle-upper limit temperature field 1823 is an input field that receives an input of the upper limit temperature used for filtering by the upper/lower limit filtering unit 715. The nozzle-lower limit temperature field 1824 is an input field that receives an input of the lower limit temperature used for filtering by the upper/lower limit filtering unit 715.

The target initial value (uncorrected nozzle temperature-set value) field 1825 is an input field that receives an input of the nozzle temperature-set value 721 to be stored in the storage medium 702 in a case where “OFF” is selected in the in-mold device molding material temperature control field 1801. Further, the target initial value (uncorrected nozzle temperature-set value) field 1825 is a display field that displays the nozzle temperature-set value 721 to be stored in the storage medium 702 in a case where “ON” is selected in the in-mold device molding material temperature control field 1801. The target initial value (uncorrected nozzle temperature-set value) field 1825 requires an initial input in a case where “OFF” is selected in the in-mold device molding material temperature control field 1801. In a case where “ON” is selected in the in-mold device molding material temperature control field 1801, the target initial value (uncorrected nozzle temperature-set value) field 1825 may be an input field until an initial input is received and may be a display field after an input is received.

The molding material temperature-adjustment completion time 1831 is a display field that displays the number of shots, a time, or a ratio (percentage) required until the measured temperature of the nozzle 320 reaches the nozzle temperature-set value 721 corrected by the set temperature correction unit 714 which is calculated by the ultimate value calculator 718. In the example shown in FIG. 8, the number of shots required until the measured temperature of the nozzle 320 reaches the nozzle temperature-set value 721 is displayed. For example, since the number of shots required until the measured temperature of the nozzle 320 reaches the nozzle temperature-set value 721 is displayed, a user can ascertain molding products that have been molded until a condition is satisfied.

Since the display control device 719 according to the present embodiment displays the temperature setting screen shown in FIG. 8, a user can recognize the current temperature situation of the injection molding machine 10 and can easily make settings related to the temperature of the molding material in the mold device 800.

An example in which the nozzle temperature-set value 721 is corrected on the basis of the temperature of the molding material in the mold device 800 to stabilize the temperature of the molding material in the mold device 800 has been described in the above-mentioned embodiment. However, the above-mentioned embodiment is not limited to the example in which the nozzle temperature-set value 721 is corrected to stabilize the temperature of the molding material in the mold device 800.

That is, the control device 700 may generate a control command, which is to be given to the heating unit 313-5 for a zone Z5, on the basis of a measured temperature that is measured by the surface temperature measurement sensor 861. As another method, for example, the control device 700 may correct a control command for the heating unit 313-5, which is based on a temperature measured by the temperature detector 314-5 for a zone Z5, according to the temperature of the molding material in the mold device 800. For example, a value corresponding to a difference between a set value of the temperature of the molding material in the mold device 800 (the molding material temperature-set value 722) and a measured temperature may be added to the temperature of the nozzle 320 that is measured by the temperature detector 314-5.

Any method may be used as long as the temperature of the heating unit 313-5 for a zone Z5 is adjusted on the basis of the temperature of the molding material in the mold device 800 as described above.

### Another Embodiment

An example in which the temperature of the heating unit 313-5 for a zone Z5, that is, the nozzle 320, is adjusted on the basis of the temperature of the molding material in the mold device 800 has been described in the embodiment. However, the adjustment of a temperature is not limited to only the nozzle 320, and may be performed on the cylinder 310. Accordingly, a case where the temperatures of the nozzle 320 and the cylinder 310 are adjusted on the basis of the temperature of the molding material in the mold device 800 will be described in another embodiment.

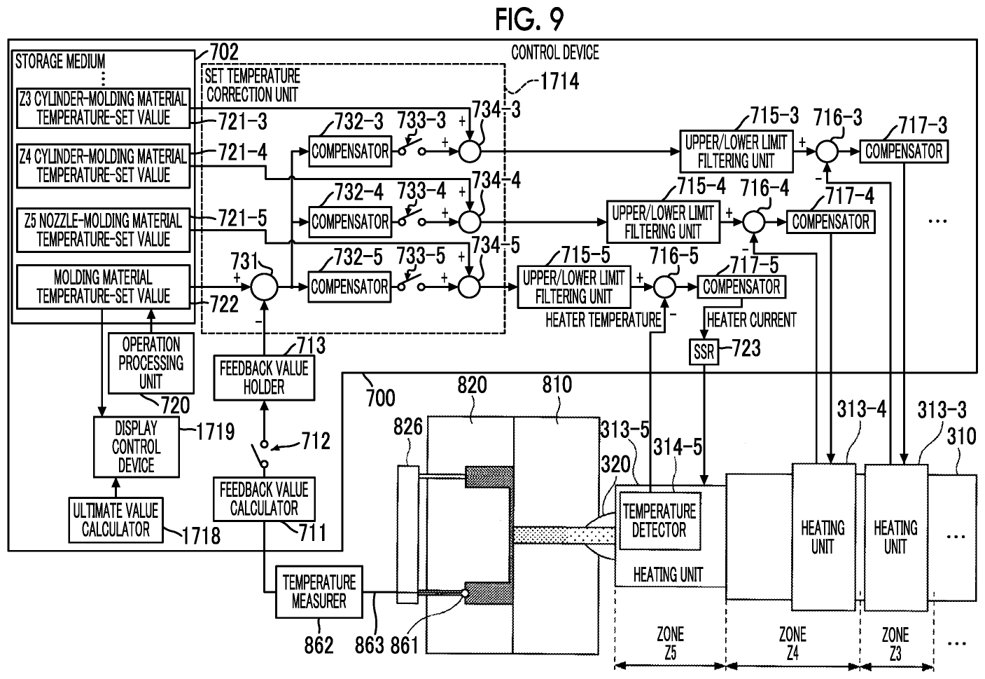

FIG. 9 is a diagram showing a configuration example of a control device 700 of the present embodiment. As shown in FIG. 9, a configuration shown in FIG. 9 is realized by a control circuit 701 provided in the control device 700.

As shown in FIG. 9, the control device 700 includes a feedback value calculator 711, an update switch 712, a feedback value holder 713, a set temperature correction unit 1714, upper/lower limit filtering units 715-5 to 715-3, calculators 716-5 to 716-3, compensators 717-5 to 717-3, an ultimate value calculator 1718, a display control device 1719, an operation processing unit 720, and a solid state relay 723. Further, a storage medium 702 stores a Z5 nozzle-molding material temperature-set value 721-5, a Z4 cylinder-molding material temperature-set value 721-4, a Z3 cylinder-molding material temperature-set value 721-3, and a molding material temperature-set value 722. The set temperature correction unit 1714 includes a calculator 731, compensators 732-5 to 732-3, correction changeover switches 733-5 to 733-3, and adders 734-5 to 734-3. Accordingly, the set temperature correction unit 1714 corrects the Z5 nozzle-molding material temperature-set value 721-5, the Z4 cylinder-molding material temperature-set value 721-4, and the Z3 cylinder-molding material temperature-set value 721-3, which are set to control heating units 313-5 to 313-3, on the basis of a measured temperature that is measured by the surface temperature measurement sensor 861. Further, an example in which the heating unit 313-5 is provided with the solid state relay 723 will be described in the present embodiment, but the other heating units (for example, the heating units 313-4 and 313-3) may also be provided with solid state relays. The same components as those of the embodiment will be denoted by the same reference numerals as those of the embodiment, and the description thereof will be omitted.

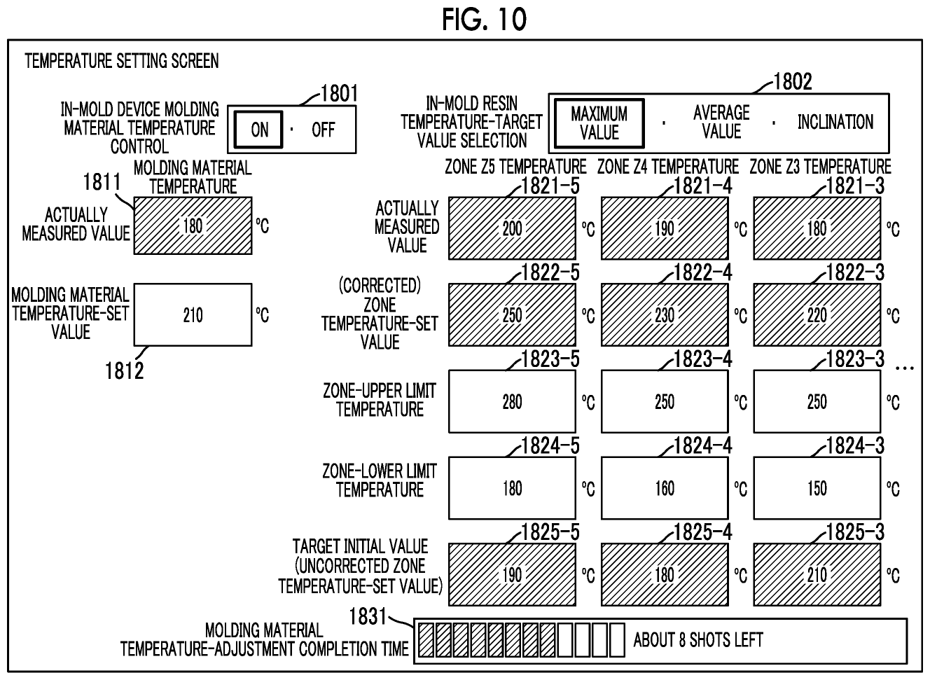

A case where the temperatures of the adders 734-5 to 734-3 of zones Z5 to Z3 are adjusted will be described as shown in FIGS. 9 and 10 in the present embodiment. However, since temperatures are also adjusted in zones Z2 and Z1 in the same manner as in the zones Z5 to Z3, the description thereof will be omitted.

The Z5 nozzle-molding material temperature-set value 721-5 is a value that is set by a user and is a target temperature that is set to control the heating unit 313-5 provided on the nozzle 320. The Z4 cylinder-molding material temperature-set value 721-4 is a target temperature that is set to control the heating unit 313-4 provided in the zone Z4 of the cylinder 310. The Z3 cylinder-molding material temperature-set value 721-3 is a target temperature that is set to control the heating unit 313-3 provided in the zone Z3 of the cylinder 310.

The set temperature correction unit 1714 corrects the Z5 nozzle-molding material temperature-set value 721-5, the Z4 cylinder-molding material temperature-set value 721-4, and the Z3 cylinder-molding material temperature-set value 721-3 on the basis of a difference between the molding material temperature-set value 722 and the feedback value that is held in the feedback value holder 713.

The compensators 732-5 to 732-3, the correction changeover switches 733-5 to 733-3, and the adders 734-5 to 734-3 of the set temperature correction unit 1714 are provided in the zones Z5 to Z3, respectively. The compensators 732-5 to 732-3, the correction changeover switches 733-5 to 733-3, and the adders 734-5 to 734-3 perform the same processing as the compensator 732, the correction changeover switch 733, and the adder 734 of the embodiment except that the compensators 732-5 to 732-3, the correction changeover switches 733-5 to 733-3, and the adders 734-5 to 734-3 are provided in the zones, respectively. In addition, correction factors may be set to be different in the respective zones. For example, it is conceivable to provide gain calculation units (for example, multipliers that multiply input values by correction factors) having different correction factors on paths for the zones, respectively. For example, a correction factor that is increased or reduced depending on a distance to the mold device 800 is conceivable as a correction factor different in the respective zones.

Accordingly, since the Z5 nozzle-molding material temperature-set value 721-5, the Z4 cylinder-molding material temperature-set value 721-4, and the Z3 cylinder-molding material temperature-set value 721-3 are corrected according to the temperature of the molding material in the mold device 800, the temperature of the molding material in the mold device 800 can be stabilized.

The upper/lower limit filtering units 715-5 to 715-3 determine whether or not the Z5 nozzle-molding material temperature-set value 721-5, the Z4 cylinder-molding material temperature-set value 721-4, and the Z3 cylinder-molding material temperature-set value 721-3 corrected by the set temperature correction unit 1714 are included in predetermined temperature ranges, respectively. The temperature ranges are set for the respective zones by a user.

In a case where the upper/lower limit filtering units 715-5 to 715-3 determine that the Z5 nozzle-molding material temperature-set value 721-5, the Z4 cylinder-molding material temperature-set value 721-4, and the Z3 cylinder-molding material temperature-set value 721-3 are not included in the ranges set for the respective zones, the upper/lower limit filtering units 715-5 to 715-3 change the Z5 nozzle-molding material temperature-set value 721-5, the Z4 cylinder-molding material temperature-set value 721-4, and the Z3 cylinder-molding material temperature-set value 721-3 so that the Z5 nozzle-molding material temperature-set value 721-5, the Z4 cylinder-molding material temperature-set value 721-4, and the Z3 cylinder-molding material temperature-set value 721-3 are included in the ranges, respectively.

The calculators 716-5 to 716-3 subtract temperatures (measured cylinder temperatures), which are measured by temperature detectors 314-5 to 314-3, from the Z5 nozzle-molding material temperature-set value 721-5, the Z4 cylinder-molding material temperature-set value 721-4, and the Z3 cylinder-molding material temperature-set value 721-3, which are output from the upper/lower limit filtering units 715-5 to 715-3, to calculate difference values that are used to adjust the heating units 313-5 to 313-3 for the zones, respectively.

The compensators 732-5 to 732-3 perform compensation controls on the difference values for the adjustment of the heating units 313-5 to 313-3 that are calculated by the calculators 716-5 to 716-3, respectively.

Since the control device 700 has the above-mentioned configuration, the control device 700 can control the temperatures of the nozzle 320 and the cylinder 310 on the basis of the temperature of the molding material in the mold device 800.

The ultimate value calculator 1718 calculates the numbers of shots, times, or ratios (percentages) that are required until the measured temperatures of the temperature detectors 314-5 to 314-3 in the zones Z5 to Z3 reach a corrected Z5 nozzle-molding material temperature-set value 721-5, a corrected Z4 cylinder-molding material temperature-set value 721-4, and a corrected Z3 cylinder-molding material temperature-set value 721-3, respectively. Then, the ultimate value calculator 1718 outputs any one of the numbers of shots, the times, or the ratios (percentages), which are calculated in the respective zones, to the display control device 1719. For example, in a case where the ultimate value calculator 1718 outputs the number of shots, it is conceivable to output the number of shots that is largest among the numbers of shots calculated in the respective zones.

Next, a user's operation will be described. FIG. 10 is a diagram illustrating a temperature setting screen that is displayed by the display control device 1719 and that is used to control the temperatures of the nozzle 320 and the cylinder 310. As shown in FIG. 10, an in-mold device molding material temperature control field 1801 and a target value selection field 1802 are displayed on the temperature setting screen. Further, an actually measured value field 1811 and a molding material temperature-set value field 1812 are displayed on the temperature setting screen as fields for the temperature of the molding material. Furthermore, an actually measured value field 1821-5, a (corrected) zone temperature-set value field 1822-5, a zone-upper limit temperature field 1823-5, a zone-lower limit temperature field 1824-5, and a target initial value (uncorrected zone temperature-set value) field 1825-5 are displayed on the temperature setting screen as fields for the temperature of the nozzle in the zone Z5. Moreover, an actually measured value field 1821-4, a (corrected) zone temperature-set value field 1822-4, a zone-upper limit temperature field 1823-4, a zone-lower limit temperature field 1824-4, and a target initial value (uncorrected zone temperature-set value) field 1825-4 are displayed on the temperature setting screen as fields for the temperature of the cylinder in the zone Z4. Further, an actually measured value field 1821-3, a (corrected) zone temperature-set value field 1822-3, a zone-upper limit temperature field 1823-3, a zone-lower limit temperature field 1824-3, and a target initial value (uncorrected zone temperature-set value) field 1825-3 are displayed on the temperature setting screen as fields for the temperature of the cylinder in the zone Z3. In addition, a molding material temperature-adjustment completion time 1831 is displayed on the temperature setting screen. The operation processing unit 720 performs update processing corresponding to values entered in input fields among these fields. The same fields as those shown in FIG. 8 will be denoted by the same reference numerals as those shown in FIG. 8, and the description thereof will be omitted.

The actually measured value field 1821-5 is a display field that displays the temperature of the nozzle 320 measured by the temperature detector 314-5 for a zone Z5. The actually measured value field 1821-4 is a display field that displays the temperature of the cylinder 310 measured by the temperature detector 314-4 for a zone Z4. The actually measured value field 1821-3 is a display field that displays the temperature of the cylinder 310 measured by the temperature detector 314-3 for a zone Z3.

The (corrected) zone temperature-set value field 1822-5 for a zone Z5 is a display field that displays the Z5 nozzle-molding material temperature-set value 721-5 corrected by the set temperature correction unit 1714 in a case where “ON” is selected in the in-mold device molding material temperature control field 1801. The (corrected) zone temperature-set value field 1822-4 for a zone Z4 is a display field that displays the Z4 cylinder-molding material temperature-set value 721-4 corrected by the set temperature correction unit 1714 in a case where “ON” is selected in the in-mold device molding material temperature control field 1801. The (corrected) zone temperature-set value field 1822-3 for a zone Z3 is a display field that displays the Z3 cylinder-molding material temperature-set value 721-3 corrected by the set temperature correction unit 1714 in a case where “ON” is selected in the in-mold device molding material temperature control field 1801.

The zone-upper limit temperature field 1823-5 for a zone Z5 is an input field that receives an input of an upper limit temperature used for filtering by the upper/lower limit filtering unit 715-5 for a zone Z5. The zone-lower limit temperature field 1824-5 for a zone Z5 is an input field that receives an input of a lower limit temperature used for filtering by the upper/lower limit filtering unit 715-5 for a zone Z5.

The zone-upper limit temperature field 1823-4 for a zone Z4 is an input field that receives an input of an upper limit temperature used for filtering by the upper/lower limit filtering unit 715-4 for a zone Z4. The zone-lower limit temperature field 1824-4 for a zone Z4 is an input field that receives an input of a lower limit temperature used for filtering by the upper/lower limit filtering unit 715-4 for a zone Z4.

The zone-upper limit temperature field 1823-3 for a zone Z3 is an input field that receives an input of an upper limit temperature used for filtering by the upper/lower limit filtering unit 715-3 for a zone Z3. The zone-lower limit temperature field 1824-3 for a zone Z3 is an input field that receives an input of a lower limit temperature used for filtering by the upper/lower limit filtering unit 715-3 for a zone Z3.

The target initial value (uncorrected zone temperature-set value) field 1825-5 for a zone Z5 is an input field that receives an input of the Z5 nozzle-molding material temperature-set value 721-5 to be stored in the storage medium 702 in a case where “OFF” is selected in the in-mold device molding material temperature control field 1801. Further, the target initial value (uncorrected zone temperature-set value) field 1825-5 is a display field that displays the Z5 nozzle-molding material temperature-set value 721-5 to be stored in the storage medium 702 in a case where “ON” is selected in the in-mold device molding material temperature control field 1801.

The target initial value (uncorrected zone temperature-set value) field 1825-4 for a zone Z4 is an input field that receives an input of the Z4 cylinder-molding material temperature-set value 721-4 to be stored in the storage medium 702 in a case where “OFF” is selected in the in-mold device molding material temperature control field 1801. Further, the target initial value (uncorrected zone temperature-set value) field 1825-4 is a display field that displays the Z4 cylinder-molding material temperature-set value 721-4 to be stored in the storage medium 702 in a case where “ON” is selected in the in-mold device molding material temperature control field 1801.

The target initial value (uncorrected zone temperature-set value) field 1825-3 for a zone Z3 is an input field that receives an input of the Z3 cylinder-molding material temperature-set value 721-3 to be stored in the storage medium 702 in a case where “OFF” is selected in the in-mold device molding material temperature control field 1801. Further, the target initial value (uncorrected zone temperature-set value) field 1825-3 is a display field that displays the Z3 cylinder-molding material temperature-set value 721-3 to be stored in the storage medium 702 in a case where “ON” is selected in the in-mold device molding material temperature control field 1801.

Since the display control device 1719 according to the present embodiment displays the temperature setting screen shown in FIG. 10, a user can recognize the current temperature situation of the injection molding machine 10 and can easily make settings related to the temperature of the molding material in the mold device 800.

An example in which the control device 700 of the present embodiment adjusts the temperatures of all the heating units 313-1 to 313-5 in the zones Z1 to Z5 on the basis of the temperature of the molding material in the mold device 800 has been described. However, an object of which the temperature is to be adjusted is not limited to the heating unit that adjusts a temperature. That is, the heating units in the zones, which are to be controlled on the basis of the temperature of the molding material in the mold device, can be an arbitrary combination. For example, the control device 700 may adjust the temperatures of the heating units 313-1 to 313-4 in the zones Z1 to Z4 without adjusting the temperature of the nozzle 320. Further, the control device 700 may adjust the temperature of any one or more of the heating units 313-1 to 313-4 in the zones Z1 to Z4. As another example, the control device 700 may adjust the temperatures of a combination of the heating unit 313-5 in the zone Z5 and any one or more of the heating units 313-1 to 313-4 in the zones Z1 to Z4.

Examples in which one surface temperature measurement sensor is provided in the mold device 800 have been described in the above-mentioned embodiments. However, the number of surface temperature measurement sensors provided in the mold device 800 is not limited to one, and a plurality of surface temperature measurement sensors may be provided in the mold device 800.

In the above-mentioned embodiments, the temperature of at least one of the nozzle 320 and the cylinder 310 is adjusted according to the surface temperature measurement sensor provided in the mold device 800. Accordingly, a variation in the temperature of the molding material in the mold device 800 is suppressed to improve the stability of the molding of molding products. Therefore, the stable supply of molding products can be realized.

The injection molding machines according to the embodiments of the present invention have been described above, but the present invention is not limited to the above-mentioned embodiments and the like. The present invention may have various changes, modifications, substitutions, additions, deletions, and combinations without departing from the scope described in claims. Naturally, these also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
a nozzle that is provided in an injection device filling a mold device with a molding material;
a nozzle temperature measurement unit that measures a temperature of the nozzle;
an in-mold temperature measurement unit that measures a temperature of the molding material in the mold device; and
a control device that controls the temperature of the nozzle on the basis of a measured nozzle temperature measured by the nozzle temperature measurement unit and a measured in-mold temperature measured by the in-mold temperature measurement unit.

2. The injection molding machine according to claim 1,
wherein the control device includes a set temperature correction unit that corrects a set temperature of the nozzle on the basis of the measured in-mold temperature measured by the in-mold temperature measurement unit, and controls the temperature of the nozzle such that the measured nozzle temperature measured by the nozzle temperature measurement unit reaches the corrected set temperature.

3. The injection molding machine according to claim 1, further comprising:
a nozzle heating unit that heats the nozzle,
wherein the control device generates a control command, which is to be given to the nozzle heating unit, on the basis of the measured in-mold temperature measured by the in-mold temperature measurement unit.

4. The injection molding machine according to claim 1,
wherein the control device controls the temperature of the nozzle on the basis of the measured nozzle temperature and the measured in-mold temperature that are obtained in a case where the mold device is filled with the molding material.

5. The injection molding machine according to claim 2, further comprising:
a calculation unit that calculates a correction value for the set temperature of the nozzle on the basis of the measured in-mold temperature measured by the in-mold temperature measurement unit; and
a holding unit that holds the correction value calculated by the calculation unit,
wherein the set temperature correction unit corrects the set temperature on the basis of the correction value held in the holding unit.

6. The injection molding machine according to claim 2, further comprising:
a number-of-shot calculation unit that calculates the number of shots, which is required until the temperature of the nozzle reaches the set temperature corrected by the set temperature correction unit, on the basis of the measured nozzle temperature measured by the nozzle temperature measurement unit.

7. The injection molding machine according to claim 2, further comprising:
a filter unit that determines whether or not the set temperature corrected by the set temperature correction unit is included in a predetermined temperature range and that changes the set temperature such that the set temperature is included in the range in a case where the filter unit determines that the set temperature is not included in the range.

8. An injection molding machine comprising:
a cylinder that is provided in an injection device filling a mold device with a molding material;
a cylinder temperature measurement unit that measures a temperature of the cylinder;
an in-mold temperature measurement unit that measures a temperature of the molding material in the mold device; and
a control device that controls the temperature of the cylinder on the basis of a measured cylinder temperature measured by the cylinder temperature measurement unit and a measured in-mold temperature measured by the in-mold temperature measurement unit.
